(19) United States
(12) Patent Application Publication
(10) Pub. No.: US 2008/0284906 A1
(43) Pub. Date: Nov. 20, 2008

(54) Devices and Methods for Transforming Coding Coefficients of Video Signals

(75) Inventors: Wai Kuen Cham, Hong Kong (CN); Chi Keung Fong, Hong Kong (CN)

Correspondence Address: FISH & RICHARDSON, PC, P.O. BOX 1022, MINNEAPOLIS, MN, 55440-1022, US

(73) Assignee: The Chinese University of Hong Kong

(21) Appl. No.: 12/096,531

(22) PCT Filed: Dec. 8, 2006
(86) PCT No.: PCT/CN06/03350

§ 371 Date: Jun. 20, 2008

(30) Foreign Application Priority Data
Dec. 8, 2005 (CN) 200510134530.6

(51) Int. Cl. H04N 7/30

(52) U.S. Cl. 348/441; 348/E07.003

(57) ABSTRACT

Disclosed are a device and a method for transforming a first coding coefficients of video signals into a second coding coefficients of the video signals. The device includes a first storing means for storing the first coding coefficients; a second storing means for storing a transform matrix; a multiplication means for multiplying the first coding coefficients by coefficients of the transform matrix; an addition means for adding each of values resulted from the multiplication operation of the multiplication means to form a sum; and a shifting means for shifting the sum to obtain the second coding coefficients. According to the present invention, signals compressed by various transforms may be transformed to each other, so as to make various compression signals compatible. Thus, the signals can be compatible with more standards and are more universal.

### CROSS-REFERENCE TO RELATED APPLICATIONS

This application is a national stage application of and claims the benefit of PCT/CN2006/003350 filed on Dec. 8, 2006, now WO 2007/065378, which claims the benefit of priority from Chinese Application No. 200510134530.6, filed on Dec. 8, 2005. These applications are incorporated by reference as part of the specification of this application.

### FIELD OF THE INVENTION

This invention refers to a device and method for transforming coding coefficients of video signals, particularly to transform video compression coding coefficients to realize a transform between DCT (Discrete Cosine Transform) compression coding signals and ICT (Integer Cosine Transform) compression coding signals, as well as a transform between signals compressed by different ICT coding modes.

### BACKGROUND OF THE INVENTION

The development of the technology of video compression and codec brought about some international standards like MPEG1, MPEG2, H.261, H.262, H.263 and H.264, wherein an eight-order DCT is used in most of standards. Only FRExt in H.264/MPEG-4 (Part 10) AVC adopts an eight-order ICT.

H.264/MPEG-4 (Part 10) AVC (ITU-T H.264/MPEG-4 (Part 10) Advanced Video Coding, “H.264/AVC” for short) is a new international standard developed by a JVT (Joint Video Team) composed of VCEG (Video Coding Experts Group) of ITU-C and MPEG (Moving Picture Experts Group) of ISO/IEC. The efficiency of this standard is about twice of that of MPEF-2. A new attachment FRExt (Fidelity Range Extensions) was presented in July, 2004, which makes the efficiency to be further improved. An eight-order ICT was proposed in the attachment to perform the compression of video signals due to an integer calculation of the ICT, which can simplify the compression and take less resource in view of the DCT.

WMV9 (Microsoft Windows Media 9) was newly developed for networks and broadcasting as well. A video core of the WMV9 is a video codec known as Windows Media 9, which achieves a tradeoff between the load of calculation and the qualify of images. The WMV9 performing ICT video compression has become one of the standards acceptable to Society of Motion Picture and Television Engineers.

In view of the above, there is a need to perform a transform between DCT compression signals and ICT compression signals so as to make H.264/AVC compression signals compatible with other standards.

In addition, although H.264/AVC signals, AVS (Audio Video Coding Standards) signals and WMV9 signals are compressed by ICT, they are not compatible with each other due to different transforms used in respective standards. Therefore, there is one more need to perform a transform among signals compressed by H.264/AVC, AVS or WMV9 so as to realize the cross-compatibility of various standards.

### SUMMARY OF THE INVENTION

In view of the above needs, the present invention provides a device and a method to perform a transform between DCT coding coefficients and ICT coding coefficients of video signals.

The present invention is also directed to a device and a method for fast transform between compression coding coefficients of video signals.

According to one aspect of the present invention, there is provided a device for transforming video signals with first coding coefficients of into video signals with second coding coefficients. The device comprises a first storing unit configured to store a first coding coefficients; a second storing unit configured to store a transform matrix; a multiplication unit configured to perform a multiplication operation for the first coding coefficients and the transform matrix; an addition unit configured to add values resulted from the multiplication operation; and a shifting unit configured to shift values resulted from the addition unit to obtain the second coding coefficients.

In a first embodiment of the present invention, the first coding coefficients are DCT video coding coefficients and the second coding coefficients are ICT video coding coefficients. In a second embodiment of the present invention, the first coding coefficients are ICT video coding coefficients and the second coding coefficients are ICT video coding coefficients different from the first coding coefficients. In a third embodiment of the present invention, the first coding coefficients are ICT video coding coefficients and the second coding coefficients are DCT video coding coefficients. The ICT video coding coefficients may be WMV9 video coding coefficients, AVS video coding coefficients and H.264/AVC video coding coefficients.

According to the present invention, the transform matrix is set up such that an error between a first signal vector and a second signal vector meet the error-requirement of the IEEE standard 1180-1990, wherein the first signal vector is transformed from the first coding coefficients by using a reverse coding in accordance with the error-requirement provided in IEEE standard 1180-1990, and the second signal vector is transformed from the second coding coefficients by using a reverse coding in accordance with the error-requirement provided in IEEE standard 1180-1990.

Preferably, the ICT video coding coefficients make up of an eight-order ICT coding coefficients matrix.

Alternatively, the transform device further comprises a third storing means for storing the values from the addition means and the shifting means. The shifting means may shift data stored in the third storing means right by 17, 13, 15, 8, 0, 12, 22 or 16 bits The second coding coefficients is 15-bit.

According to another aspect of the present invention, there is provide a method for transforming video signals with first coding coefficients into video signals with second coding coefficients, comprising: loading the first coding coefficients and a transform matrix; multiplying the first coding coefficients by the transform matrix; adding values resulted from the multiplication operation; and shifting values resulted from the adding operation to obtain the second coding coefficients. In a first embodiment of the present invention, the first coding coefficients are DCT video coding coefficients and the second coding coefficients are ICT video coding coefficients. In a second embodiment of the present invention, the first coding coefficients are ICT video coding coefficients and the second coding coefficients are ICT video coding coefficients different from the first coding coefficients. In a third embodiment of the present invention, the first coding coefficients are ICT video coding coefficients and the second coding coefficients are DCT video coding coefficients. The ICT video coding coefficients may be WMV9 video coding coefficients, AVS video coding coefficients and H.264/AVC video coding coefficients. According to the present invention, the transform matrix is set up such that an error between a first signal vector and a second signal vector meet the error-requirement of the IEEE standard 1180-1990, wherein the first signal vector is transformed from the first coding coefficients by using a reverse coding in accordance with the error-requirement provided in IEEE standard 1180-1990, and the second signal vector is transformed from the second coding coefficients by using a reverse coding in accordance with the error-requirement provided in IEEE standard 1180-1990.

Preferably, the ICT video coding coefficients make up of an eight-order ICT coding coefficients matrix.

According to the present invention, signals compressed by various transforms may be transformed with each other, so as to enable various standards to be compatible with each other.

### BRIEF DESCRIPTION OF THE DRAWINGS

FIG. 1 a block diagram for showing a device for transform of coding coefficients according to one embodiment of the present invention.

FIG. 2 shows a signal flow graph of a fast transform of coding coefficients according to one embodiment of the present invention.

FIG. 3 shows a signal flow graph of a fast transform of coding coefficients according to another embodiment of the present invention.

FIG. 4 shows a signal flow graph of a fast transform from AVS coding coefficients to WMV9 coding coefficients according to an embodiment of the present invention.

FIG. 5 shows a signal flow graph of a fast transform from H.264/AVC coding coefficients to a DCT coding coefficients according to an embodiment of the present invention.

FIG. 6 schematically shows a fast transform between DCT coding coefficients and ICT coding coefficients.

FIG. 7 schematically shows a fast transform between H.264/AVC coding coefficients and AVS coding coefficients.

FIG. 8 is a coefficient table of a transform matrix for transform from DCT coding coefficients to H.264/AVC coding coefficients according to an embodiment of the present invention.

FIG. 9 is a coefficient table of a transform matrix for transform from DCT coding coefficients to WMV9 coding coefficients according to an embodiment of the present invention.

FIG. 10 is a coefficient table of a transform matrix for transform from AVS coding coefficients to DCT coding coefficients according to an embodiment of the present invention.

FIG. 11 is a coefficient table of a transform matrix for transform from AVS coding coefficients to H.264/AVC coding coefficients according to an embodiment of the present invention.

FIG. 12 is a coefficient table of a transform matrix for transform from H.264/AVC coding coefficients to AVS coding coefficients according to an embodiment of the present invention.

FIG. 13 is a coefficient table of a transform matrix for transform from H.264/AVC coding coefficients to WMV9 coding coefficients according to an embodiment of the present invention.

FIG. 14 is a coefficient table of a transform matrix for transform from WMV9 coding coefficients to DCT coding coefficients according to an embodiment of the present invention.

FIG. 15 is a coefficient table of a transform matrix for transform from WMV9 coding coefficients to AVS coding coefficients according to an embodiment of the present invention.

FIG. 16 shows values of various transform coding coefficients according to a preferable embodiment of the present invention.

### DESCRIPTION OF THE PREFERRED EMBODIMENTS

The embodiments of the invention are illustrated with reference to drawings. The process for DCT coding and process for ICT coding are explained respectively and firstly, and the transform of various coding methods will be described later.

### DCT Coding

Setting a video signal as a vector X, DCT coding coefficients, represented as a matrix C_{dct}, are obtained through a DCT transform matrix T_{dct}:

C_{dct}=T_{dct}X (1)

X=T_{dct}⁻¹C_{dct}=T_{dct}^{t}C_{dct} (2).

### ICT Coding

Setting a video signal as a vector X, ICT coding coefficients represented as a vector C are obtained by using an ICT transform matrix Tᵢ, wherein the ICT transform matrix Tᵢ may be in the form of Tᵢ=KKE used in AVS, Tᵢ=KE used in H.264/AVC, and Tᵢ=E used in WMV9.

For a 8-order ICT (a, b, c, d, e, f, g), the matrix K and E are given as follows:

$$E = [ \begin{matrix}g & g & g & g & g & g & g & g \\ a & b & c & d & - d & - c & - b & - a \\ e & f & - f & - e & - e & - f & f & e \\ b & - d & - a & - c & c & a & d & - b \\ g & - g & - g & g & g & - g & g & g \\ c & - a & d & b & - b & - d & a & - c \\ f & - e & e & - f & - f & e & - e & f \\ d & - c & b & - a & a & - b & c & - d\end{matrix} ]$$

$$K = [ \begin{matrix}{k}_{b 3} ( 0 ) & 0 & 0 & 0 & 0 & 0 & 0 & 0 \\ 0 & {k}_{b 3} ( 1 ) & 0 & 0 & 0 & 0 & 0 & 0 \\ 0 & 0 & {k}_{b 3} ( 2 ) & 0 & 0 & 0 & 0 & 0 \\ 0 & 0 & 0 & {k}_{b 3} ( 3 ) & 0 & 0 & 0 & 0 \\ 0 & 0 & 0 & 0 & {k}_{b 3} ( 4 ) & 0 & 0 & 0 \\ 0 & 0 & 0 & 0 & 0 & {k}_{b 3} ( 5 ) & 0 & 0 \\ 0 & 0 & 0 & 0 & 0 & 0 & {k}_{b 3} ( 6 ) & 0 \\ 0 & 0 & 0 & 0 & 0 & 0 & 0 & {k}_{b 3} ( 7 )\end{matrix} ]$$

where the value of k_{b3}(i) is obtained by using the following equation, wherein E(i) represents the (i)th row of the matrix E:

∥k_{b3}(i)E(i)∥²=1

According to the definition of ICT, possible combinations of seven values a-g are infinite. Upon tradeoff between the compressibility and the efficiency, H.264/AVC uses ICT (12, 10, 6, 3, 8, 4, 8), while AVS uses ICT (10, 9, 6, 2, 10, 4, 8) and WMV9 uses ICT (16, 15, 9, 4, 16, 12). The following description is given by taking ICT (16, 15, 9, 4, 16, 12) as an example.

Setting a video signal as a vector X, when Tᵢ=KKE, namely, taking the ICT coding used in AVS, the ICT transform matrix Tᵢ is Tₐᵥₛ=KₐᵥₛKₐᵥₛEₐᵥₛ. The ICT coding matrix Cₐᵥₛ will be

Cₐᵥₛ=TₐᵥₛX=KₐᵥₛKₐᵥₛEₐᵥₛX (3)

X=Tₐᵥₛ⁻¹Cₐᵥₛ=Eₐᵥₛ^{t}Cₐᵥₛ (4)

When Tᵢ=KE, namely, taking the ICT coding used in H.264/AVC, the ICT transform matrix Tᵢ is Tₕ₂₆₄=Kₕ₂₆₄Eh₂₆₄. The ICT coding matrix Cₕ₂₆₄ will be

Cₕ₂₆₄=Tₕ₂₆₄X=Kₕ₂₆₄Eₕ₂₆₄X (5)

X=Tₕ₂₆₄⁻¹Cₕ₂₆₄=Eₕ₂₆₄^{t}Kₕ₂₆₄Cₕ₂₆₄ (6)

When Tᵢ=E, namely, the ICT coding used in WMV9, the ICT transform matrix Tᵢ is T_{wmv9}=E_{wmv9}. The ICT coding matrix C_{wmv9} will be

C_{wmv9}=T_{wmv9}X=E_{wmv9}X (7)

X=T_{wmv9}⁻¹C_{wmv9}=E_{wmv9}^{t}K_{wmv9}K_{wmv9}C_{wmv9} (8)

As stated above, in order to achieve compatibility among the DCT, H.264/AVC, AVS and WMV9 standards, it is necessary to perform a transform among H.264/AVC, AVS and WMV9 signals and DCT signals. Twelve transforms occur. Herein, the twelve transforms are classified into four classes, each including three transforms.

Assuming that a coding matrix Cᵢₙ is obtained by coding an input signal vector Xᵢₙ with any of the above-mentioned four standards (referred to as the first coding), the coding matrix Cᵢₙ is transformed, via a transform matrix Tₒᵤₜᵢₙ, to another coding matrix Cₒᵤₜ which complies with another standard (referred to as the second coding). That is, the coding matrix Cₒᵤₜ is composed of coding coefficients of an output vector Xₒᵤₜ. The transform matrix Tₒᵤₜᵢₙ can be implemented in various manners. Considering the efficiency of the matrix Tₒᵤₜᵢₙ and the accuracy of the signal coefficient Cₒᵤₜ, the present invention prefers to select Tₒᵤₜᵢₙ based on the following two rules:
1) the transform matrix Tₒᵤₜᵢₙ has a simple structure; and
2) the input coding matrix Cᵢₙ can be transformed into a signal vector \hat{X}ᵢₙ by using a reverse coding in accordance with the error-requirement provided in IEEE standard 1180-1990; and the output signal matrix Cₒᵤₜ can be transformed into a signal vector Xₒᵤₜ by using a reverse coding in accordance with the error-requirement provided in IEEE standard 1180-1990, wherein an error between signal vectors \hat{X}ᵢₙ and Xₒᵤₜ must meet the error-requirement of the IEEE standard 1180-1990.
   1. A Transform from DCT Coding Signals into Other Coding Signals
   1.1 A Transform from a DCT Coding Matrix to an AVS Coding Matrix

A DCT coding matrix is transformed to an AVS coding matrix via equations (2) and (3), namely:

Cₐᵥₛ=T_{avsdct}C_{dct}=KₐᵥₛKₐᵥₛEₐᵥₛT_{dct}^{t}C_{dct} (9)

That is, the transform matrix T_{avsdct} for transforming a DCT coding matrix into an AVS coding matrix is:

T_{avsdct}=KₐᵥₛKₐᵥₛEₐᵥₛT_{dct}^{t} (10)

and can be expressed approximately as:

$${T}_{avsdct} ( \begin{matrix}{T}_{a} , {T}_{b} , {T}_{c} , \\ {T}_{d} , {T}_{e} , {T}_{f} , {T}_{g}\end{matrix} ) \approx \frac{1}{{2}^{b}} [ \begin{matrix}{T}_{a} & 0 & 0 & 0 & 0 & 0 & 0 & 0 \\ 0 & {T}_{b} & 0 & {T}_{g} & 0 & {T}_{d} & 0 & - {T}_{f} \\ 0 & 0 & {T}_{c} & 0 & 0 & 0 & - {T}_{e} & 0 \\ 0 & - {T}_{d} & 0 & {T}_{b} & 0 & {T}_{f} & 0 & - {T}_{g} \\ 0 & 0 & 0 & 0 & {T}_{a} & 0 & 0 & 0 \\ 0 & - {T}_{g} & 0 & - {T}_{f} & 0 & {T}_{b} & 0 & - {T}_{d} \\ 0 & 0 & {T}_{e} & 0 & 0 & 0 & {T}_{c} & 0 \\ 0 & {T}_{f} & 0 & {T}_{d} & 0 & - {T}_{g} & 0 & {T}_{b}\end{matrix} ] \qquad ( 11 )$$

wherein, Tₐ, T_{b}, T_{c}, T_{d}, Tₑ, T_{f}, T_{g} and b are integers. The b represents the accuracy of the matrix. The larger b is, the more accurate the coefficients of the output coding matrix are. However, the matrix will become more complicated. Different ICT uses different (Tₐ, T_{b}, T_{c}, T_{d}, Tₑ, T_{f}, T_{g}) and b. According to above-mentioned two rules, (Tₐ, T_{b}, T_{c}, T_{d}, Tₑ, T_{f}, T_{g}) and b should meet the error requirement of the IEEE standard 1180-1990. Meanwhile, the T_{avsdct} should have a simple structure, namely, b should be a minimum.

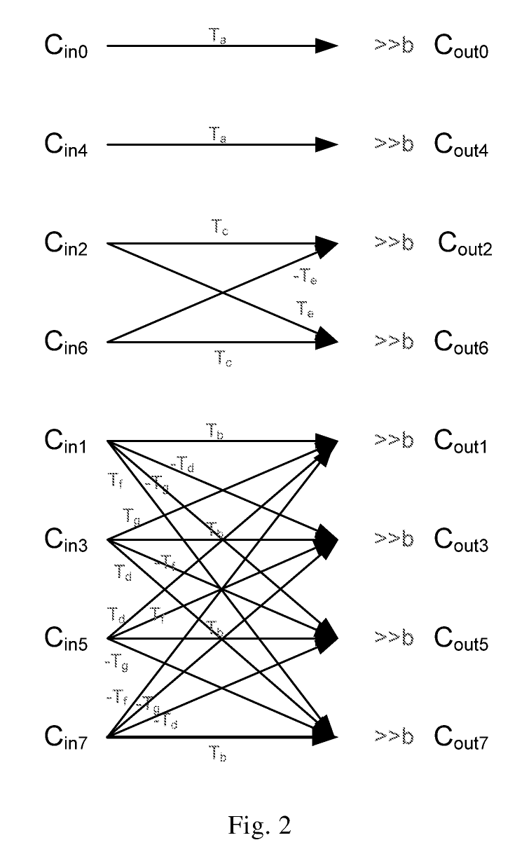

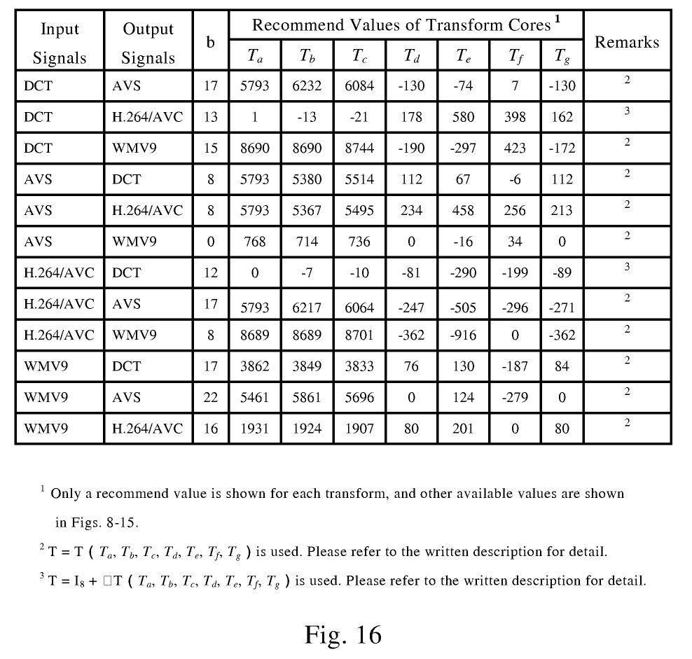

According to the rules, when the coefficients of the input DCT coding matrix are 12-bit or more and b is 17, the coefficients of the transformed coding matrix Cₐᵥₛ should be represented in 15-bit, namely, (Tₐ, T_{b}, T_{c}, T_{d}, Tₑ, T_{f}, T_{g})=(5793, 6232, 6048, −130, −74, 7, −130), as shown in FIG. 16. A fast method for this transform will be given with reference to FIG. 2.

1.2 A Transform from a DCT Coding Matrix to a H.264/AVC Coding Matrix

A DCT coding matrix is transformed to a H.264/AVC coding matrix via equations (2) and (5), namely:

Cₕ₂₆₄=T_{h264dct}C_{dct}=Kₕ₂₆₄Eₕ₂₆₄T_{dct}^{t}C_{dct} (12)

The transform matrix T_{h264dct} for transforming a DCT coding matrix into an H.264/AVC coding matrix is:

T_{h264dct}=Kₕ₂₆₄Eₕ₂₆₄T_{dct}^{t} (13)

wherein the T_{h264dct} is similar to a unit matrix and can be given approximately:

$${T}_{h 264 dct} ( \begin{matrix}{T}_{a} , {T}_{b} , {T}_{c} , \\ {T}_{d} , {T}_{e} , {T}_{f} , {T}_{g}\end{matrix} ) \approx {I}_{8} + \frac{1}{{2}^{b}} [ \begin{matrix}{T}_{a} & 0 & 0 & 0 & 0 & 0 & 0 & 0 \\ 0 & {T}_{b} & 0 & {T}_{g} & 0 & {T}_{d} & 0 & - {T}_{f} \\ 0 & 0 & {T}_{c} & 0 & 0 & 0 & - {T}_{e} & 0 \\ 0 & - {T}_{d} & 0 & {T}_{b} & 0 & {T}_{f} & 0 & - {T}_{g} \\ 0 & 0 & 0 & 0 & {T}_{a} & 0 & 0 & 0 \\ 0 & - {T}_{g} & 0 & - {T}_{f} & 0 & {T}_{b} & 0 & - {T}_{d} \\ 0 & 0 & {T}_{e} & 0 & 0 & 0 & {T}_{c} & 0 \\ 0 & {T}_{f} & 0 & {T}_{d} & 0 & - {T}_{g} & 0 & {T}_{b}\end{matrix} ] \qquad ( 14 )$$

wherein I₈ is an eight-order matrix.

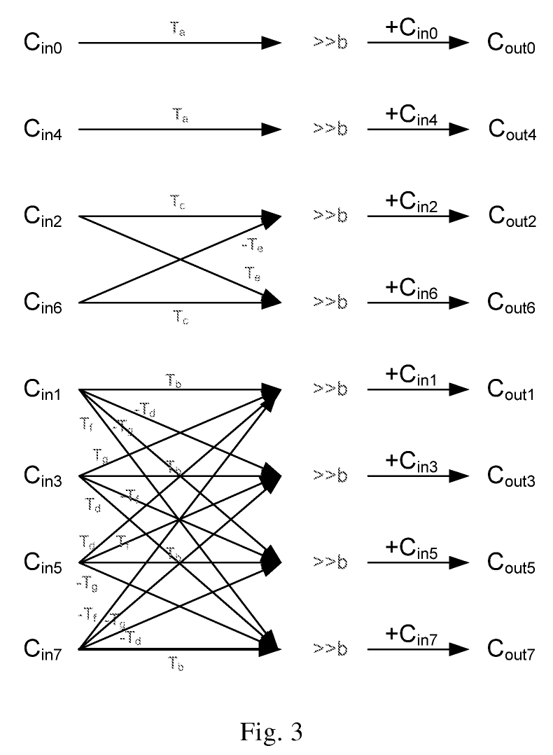

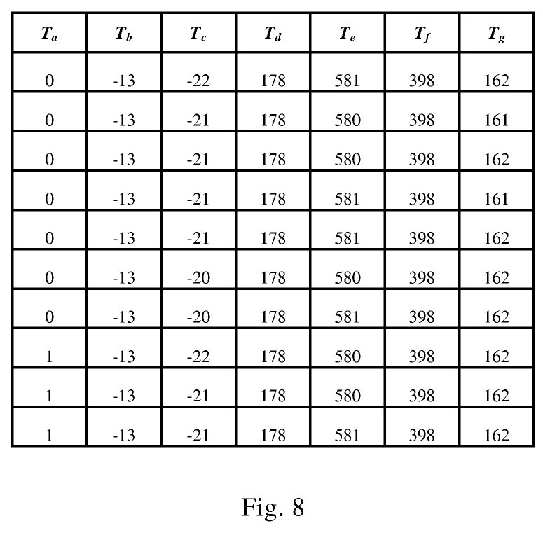

According to the rules, when the coefficients of the input DCT coding matrix are 12-bit or more and b is 13, values of Tₐ, T_{b}, T_{c}, T_{d}, Tₑ, T_{f} and T_{g} should be one of the groups shown in the tables in FIGS. 8a-8d, and the coefficients of the transformed coding matrix Cₕ₂₆₄ should be represented by 15-bit or more to meet the error requirement of the IEEE standard 1180-1990. A fast transform method for this transform is shown with reference to FIG. 3.

1.3 A Transform from a DCT Coding Matrix to a WMV9 Coding Matrix

A DCT coding matrix is transformed to a WMV9 coding matrix via equations (2) and (7), namely,

C_{wmv9}=T_{wmv9dct}C_{dct}=E_{wmv9}T_{dct}^{t}C_{dct} (15).

The transform matrix T_{wmv9dct} for transforming a DCT coding matrix into a WMV9 coding matrix is:

T_{wmv9dct}=E_{wmv9}T_{dct}^{t} (16)

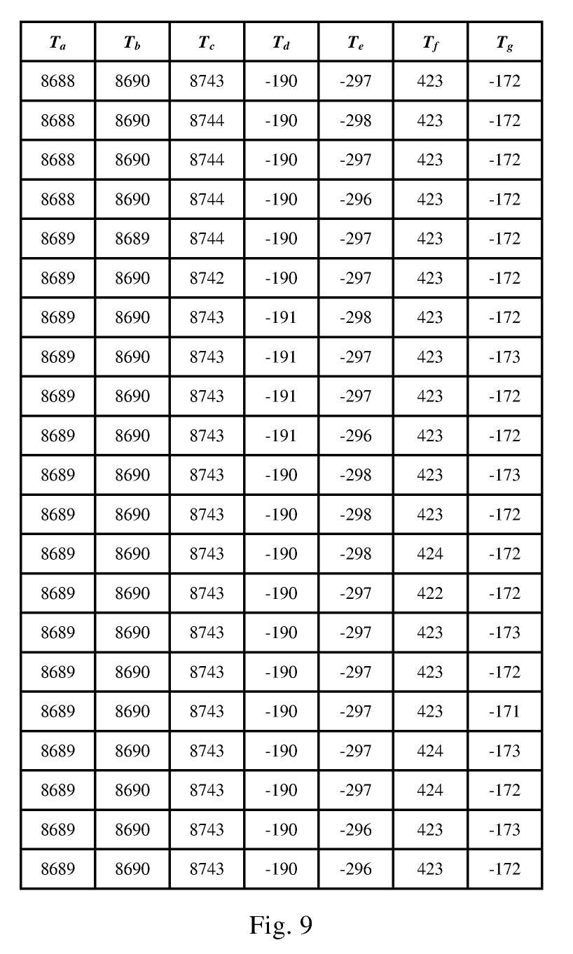

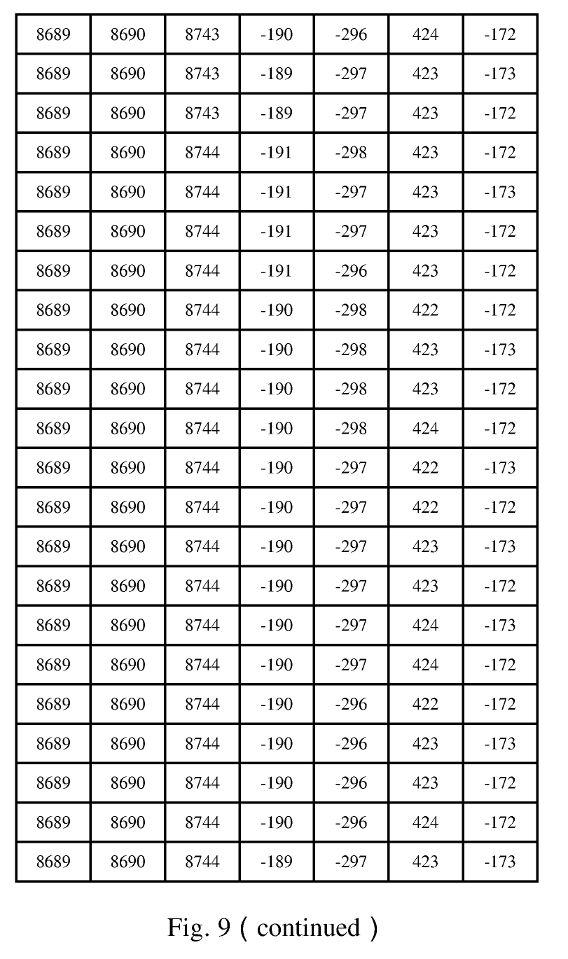

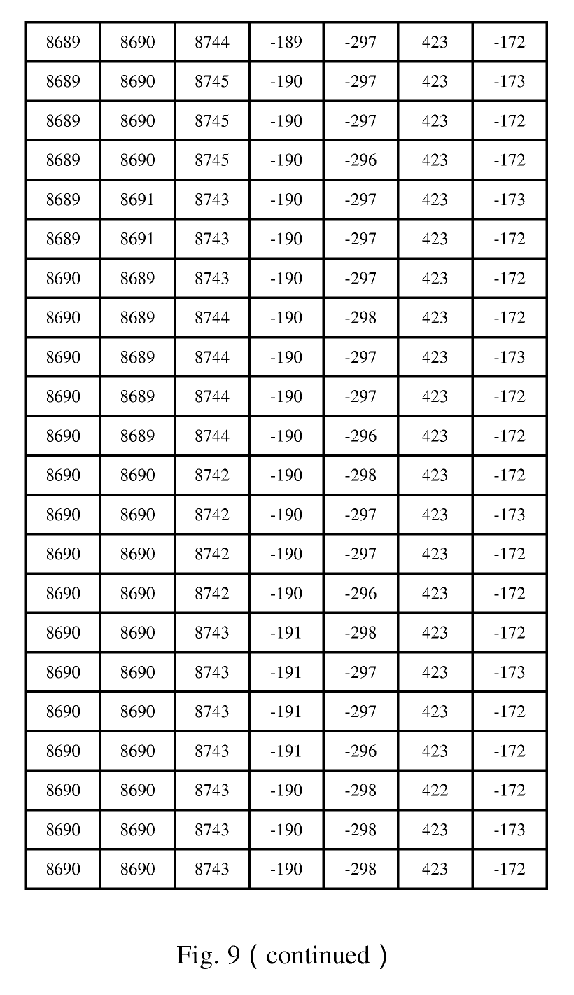

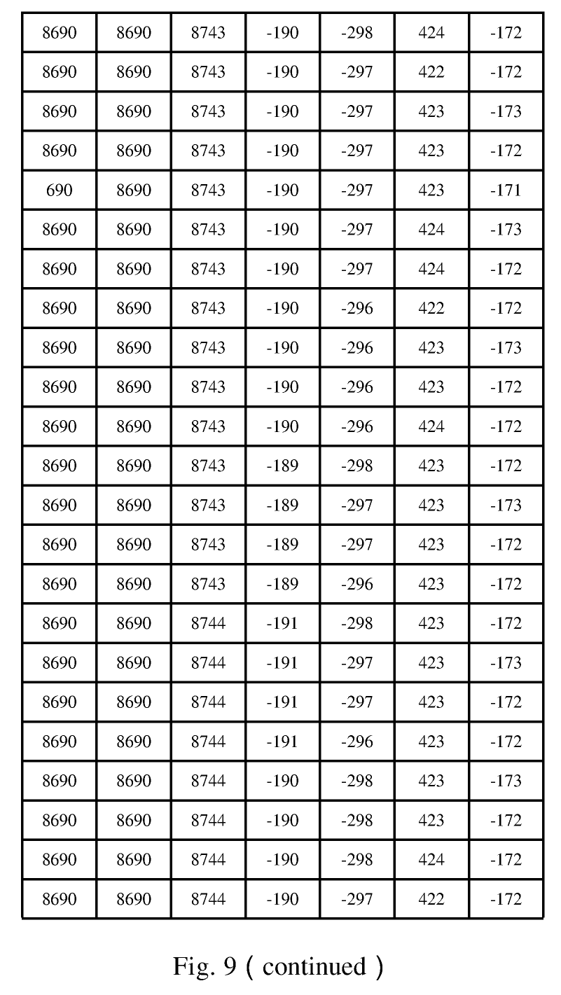

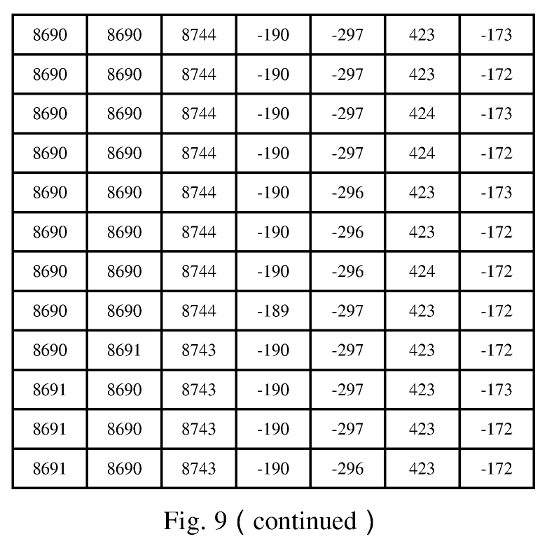

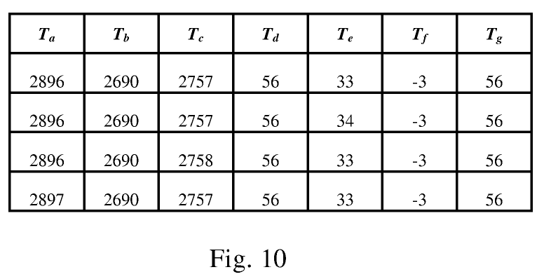

and can be expressed approximately as:

$${T}_{wmv 9 dct} ( \begin{matrix}{T}_{a} , {T}_{b} , {T}_{c} , \\ {T}_{d} , {T}_{e} , {T}_{f} , {T}_{g}\end{matrix} ) \approx \frac{1}{{2}^{b}} [ \begin{matrix}{T}_{a} & 0 & 0 & 0 & 0 & 0 & 0 & 0 \\ 0 & {T}_{b} & 0 & {T}_{g} & 0 & {T}_{d} & 0 & - {T}_{f} \\ 0 & 0 & {T}_{c} & 0 & 0 & 0 & - {T}_{e} & 0 \\ 0 & - {T}_{d} & 0 & {T}_{b} & 0 & {T}_{f} & 0 & - {T}_{g} \\ 0 & 0 & 0 & 0 & {T}_{a} & 0 & 0 & 0 \\ 0 & - {T}_{g} & 0 & - {T}_{f} & 0 & {T}_{b} & 0 & - {T}_{d} \\ 0 & 0 & {T}_{e} & 0 & 0 & 0 & {T}_{c} & 0 \\ 0 & {T}_{f} & 0 & {T}_{d} & 0 & - {T}_{g} & 0 & {T}_{b}\end{matrix} ] \qquad ( 17 )$$

wherein, according to the rules, when the coefficients of the input DCT coding matrix are 12-bit or more and b is 15, values of Tₐ, T_{b}, T_{c}, T_{d}, Tₑ, T_{f} and T_{g} should be one of the groups shown in the table in FIG. 9, and the coefficients of the transformed coding matrix C_{wmv} should be represented in 15-bit or more, so as to meet the error requirement of the IEEE standard 1180-1990. According to a preferred embodiment of the present invention, (Tₐ, T_{b}, T_{c}, T_{d}, Tₑ, T_{f}, T_{g})=(1, −13, −21, 178, 580, 398, 162), as shown in FIG. 16. A fast transform method can be shown with reference to FIG. 2.

2. A Transforming from AVS Coding Signals into Other Coding Signals
2.1 A Transform from an AVS Coding Matrix to a DCT Coding Matrix

An AVS coding matrix is transformed to a DCT coding matrix via equations (4) and (1), namely:

C_{dct}=T_{dctavs}Cₐᵥₛ=T_{dct}Eₐᵥₛ^{t}Cₐᵥₛ (18)

That is, the transform matrix T_{dctavs} for transforming an AVD coding matrix into a DCT coding matrix is:

T_{dctavs}=T_{dct}Eₐᵥₛ^{t} (19)

and can be expressed approximately as:

$${T}_{dctavs} ( \begin{matrix}{T}_{a} , {T}_{b} , {T}_{c} , \\ {T}_{d} , {T}_{e} , {T}_{f} , {T}_{g}\end{matrix} ) \approx \frac{1}{{2}^{b}} [ \begin{matrix}{T}_{a} & 0 & 0 & 0 & 0 & 0 & 0 & 0 \\ 0 & {T}_{b} & 0 & {T}_{g} & 0 & {T}_{d} & 0 & - {T}_{f} \\ 0 & 0 & {T}_{c} & 0 & 0 & 0 & - {T}_{e} & 0 \\ 0 & - {T}_{d} & 0 & {T}_{b} & 0 & {T}_{f} & 0 & - {T}_{g} \\ 0 & 0 & 0 & 0 & {T}_{a} & 0 & 0 & 0 \\ 0 & - {T}_{g} & 0 & - {T}_{f} & 0 & {T}_{b} & 0 & - {T}_{d} \\ 0 & 0 & {T}_{e} & 0 & 0 & 0 & {T}_{c} & 0 \\ 0 & {T}_{f} & 0 & {T}_{d} & 0 & - {T}_{g} & 0 & {T}_{b}\end{matrix} ] . \qquad ( 20 )$$

According to the rules, when the coefficients of the input AVS coding matrix are 12-bit or more and the b is 8, the values of Tₐ, T_{b}, T_{c}, T_{d}, Tₑ, T_{f} and T_{g} should be one of the groups shown in the table in FIG. 10, and the coefficients of the transformed coding matrix C_{dct} should be represented by 15-bit or more, so as to meet the error requirement of the IEEE standard 1180-1990. According to a preferred embodiment of the present invention, (Tₐ, T_{b}, T_{c}, T_{d}, Tₑ, T_{f}, T_{g})=(5793, 5380, 5514, 112, 67, −6, 112), as shown in FIG. 16.

2.2 A Transform from an AVS Coding Matrix to a H.264/AVC Coding Matrix

an AVS coding matrix is transformed to a H.264/AVC coding matrix via equations (4) and (5), namely:

Cₕ₂₆₄=Tₕ₂₆₄ₐᵥₛCₐᵥₛ=Kₕ₂₆₄Eₕ₂₆₄Eₐᵥₛ^{t}Cₐᵥₛ (21)

That is, the transform matrix Tₕ₂₆₄ₐᵥₛ for transforming an AVS coding matrix into a DCT coding matrix is:

Tₕ₂₆₄ₐᵥₛ=Kₕ₂₆₄Eₕ₂₆₄Eₐᵥₛ^{t} (22)

wherein the matrix Tₕ₂₆₄ₐᵥₛ may be approximately expressed as:

$${T}_{h 264 avs} ( \begin{matrix}{T}_{a} , {T}_{b} , {T}_{c} , \\ {T}_{d} , {T}_{e} , {T}_{f} , {T}_{g}\end{matrix} ) \approx \frac{1}{{2}^{b}} [ \begin{matrix}{T}_{a} & 0 & 0 & 0 & 0 & 0 & 0 & 0 \\ 0 & {T}_{b} & 0 & {T}_{g} & 0 & {T}_{d} & 0 & - {T}_{f} \\ 0 & 0 & {T}_{c} & 0 & 0 & 0 & - {T}_{e} & 0 \\ 0 & - {T}_{d} & 0 & {T}_{b} & 0 & {T}_{f} & 0 & - {T}_{g} \\ 0 & 0 & 0 & 0 & {T}_{a} & 0 & 0 & 0 \\ 0 & - {T}_{g} & 0 & - {T}_{f} & 0 & {T}_{b} & 0 & - {T}_{d} \\ 0 & 0 & {T}_{e} & 0 & 0 & 0 & {T}_{c} & 0 \\ 0 & {T}_{f} & 0 & {T}_{d} & 0 & - {T}_{g} & 0 & {T}_{b}\end{matrix} ] . \qquad ( 23 )$$

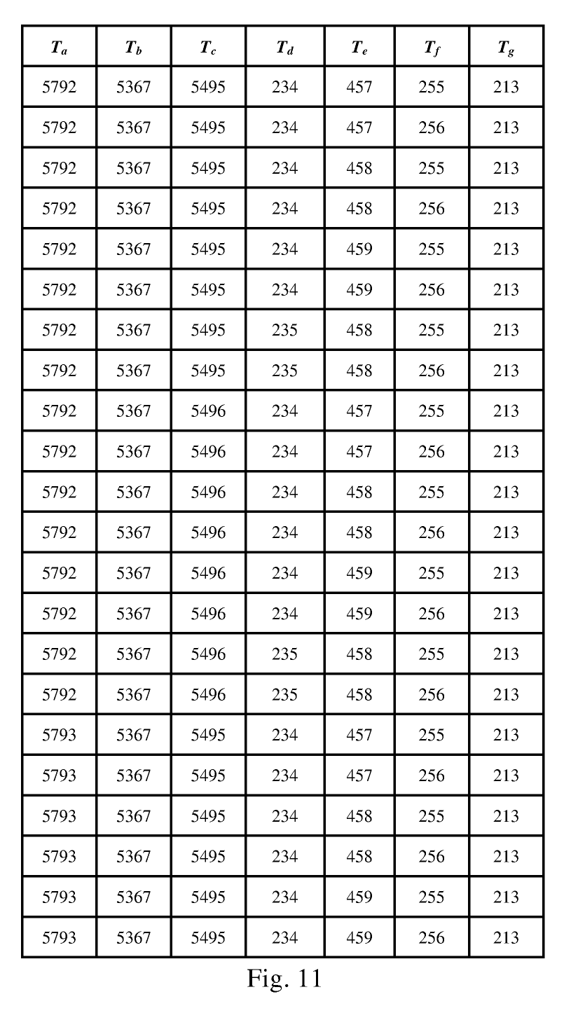

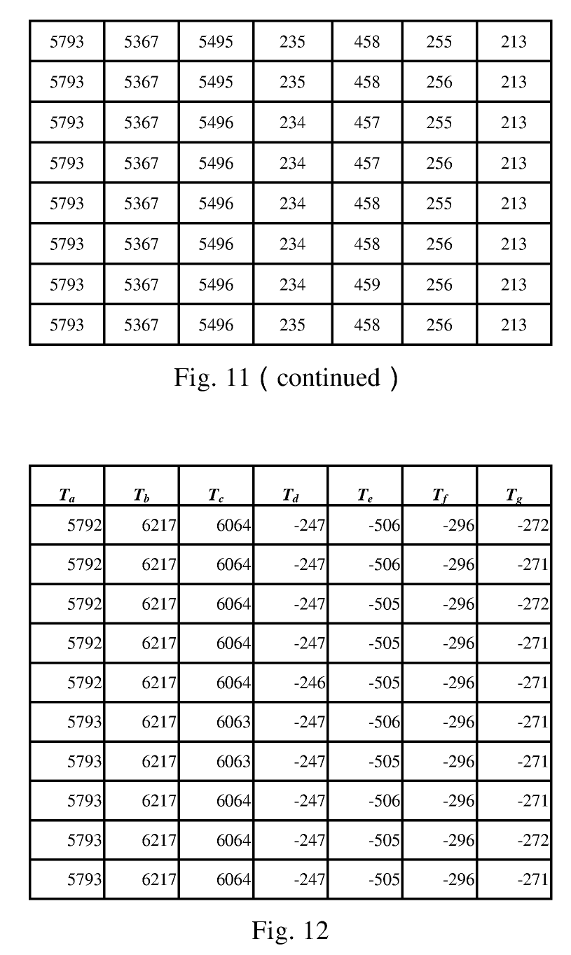

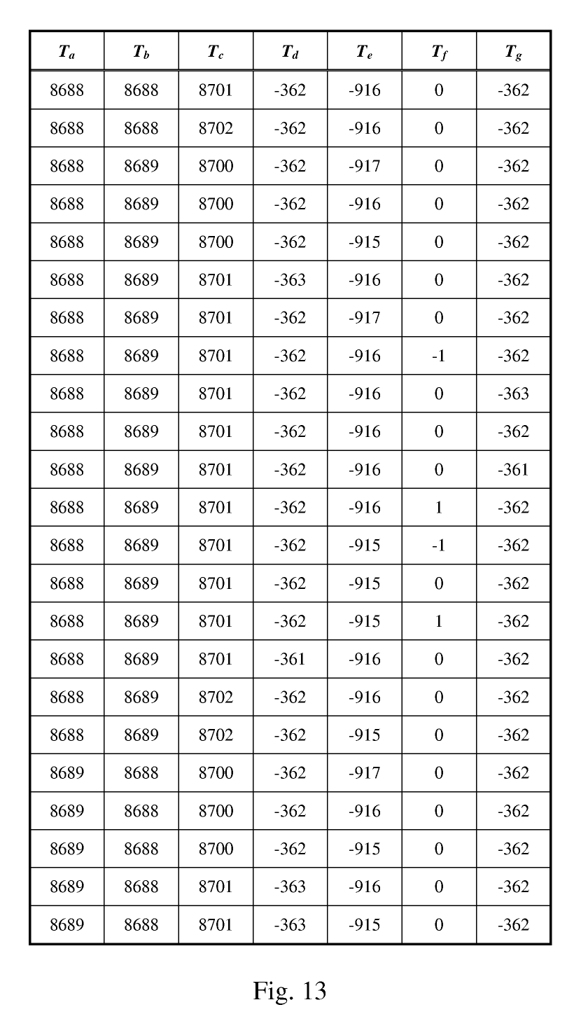

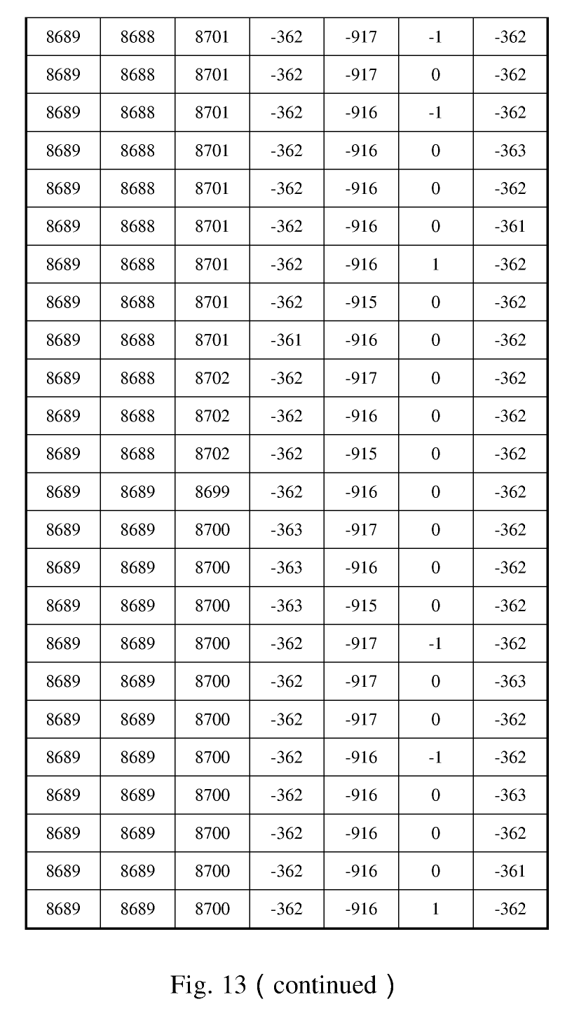

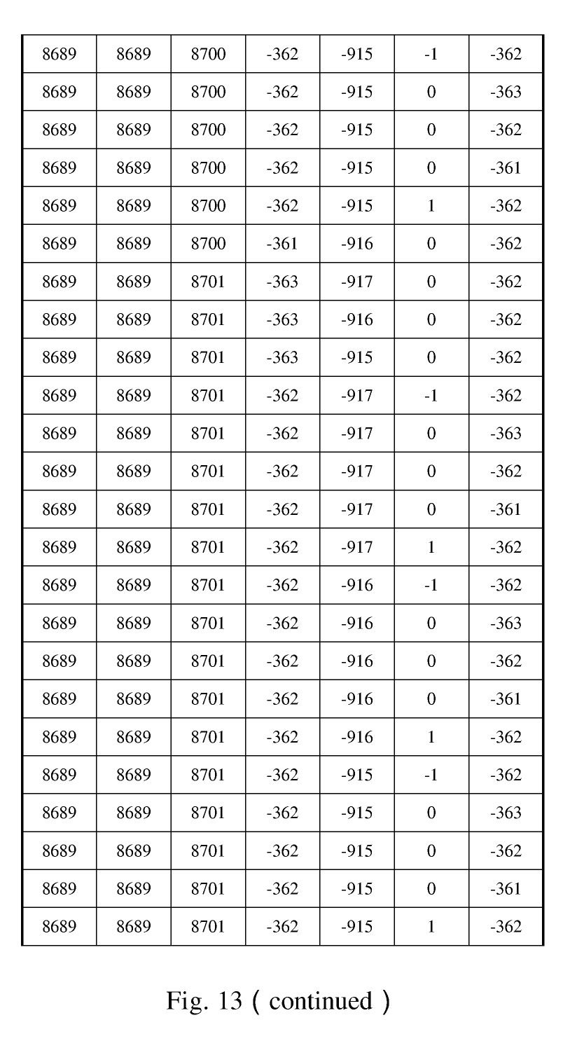

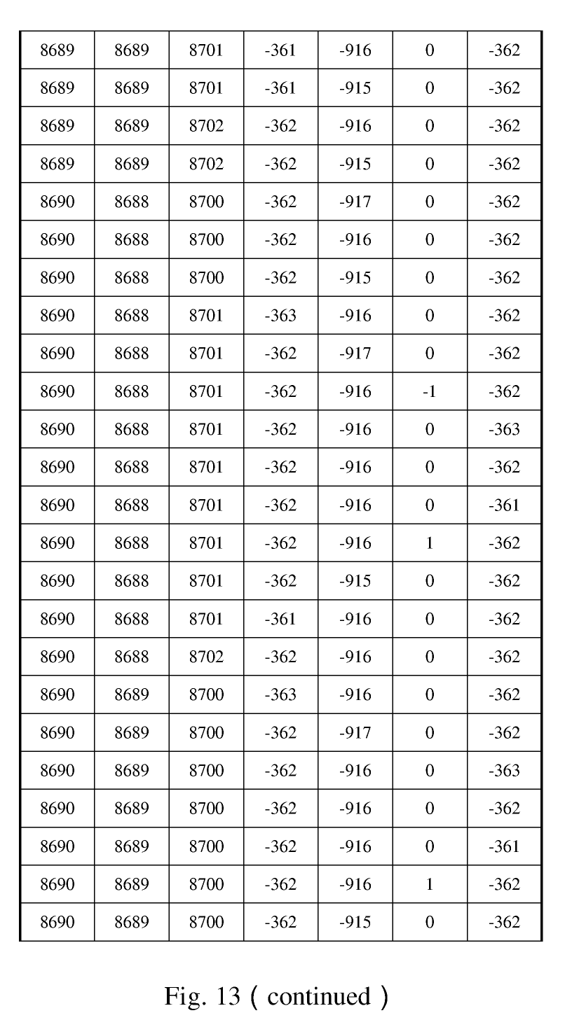

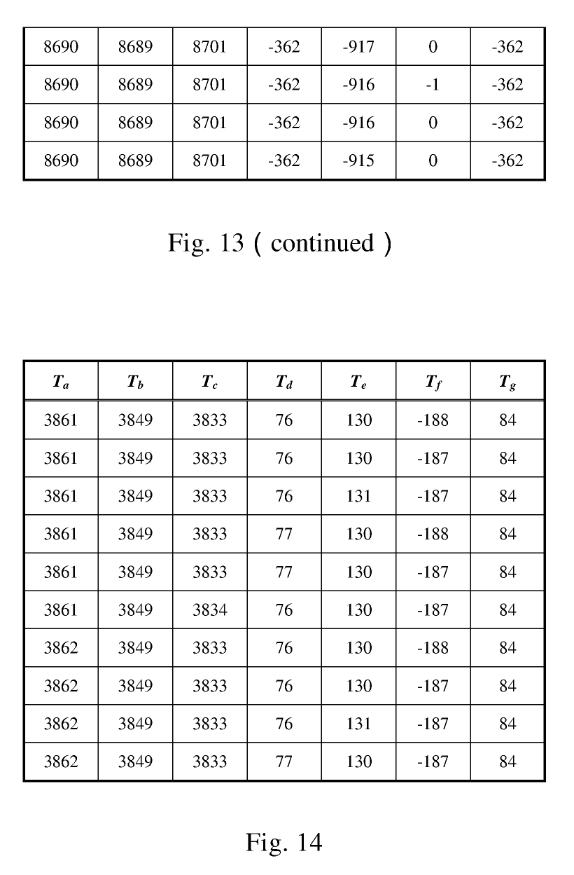

According to the rules, when the coefficients of the input AVS coding matrix are 12-bit or more and the b is 8, the values of Tₐ, T_{b}, T_{c}, T_{d}, Tₑ, T_{f} and T_{g} should be one of the groups shown in the table in FIG. 11, and the coefficients of the transformed matrix Cₕ₂₆₄ should be 15-bit or more, so as to meet the error requirement of the IEEE standard 1180-1990. According to a preferred embodiment of the present invention, (Tₐ, T_{b}, T_{c}, T_{d}, Tₑ, T_{f}, T_{g})=(5793, 5367, 5495, 234, 458, 256, 213), as shown in FIG. 16. The fast transform method for this transform is shown in FIG. 2.

2.3 A Transform from an AVS Coding Matrix to a WMV9 Coding Matrix

An AVS coding matrix is transformed to a WMV9 coding matrix via equations (4) and (7), namely:

C_{wmv9}=T_{wmv9avs}Cₐᵥₛ=E_{wmv9}Eₐᵥₛ^{t}Cₐᵥₛ (24)

That is, the transform matrix T_{wmv9} avs for transforming an AVS coding matrix into a WMV9 coding matrix is:

T_{wmvavs}=E_{wmv9}Eₐᵥₛ^{t} (25)

wherein the matrix T_{wmv9avs} may be expressed approximately as:

$${T}_{wmv 9 avs} ( \begin{matrix}{T}_{a} , {T}_{b} , {T}_{c} , \\ {T}_{d} , {T}_{e} , {T}_{f} , {T}_{g}\end{matrix} ) \approx \frac{1}{{2}^{b}} [ \begin{matrix}{T}_{a} & 0 & 0 & 0 & 0 & 0 & 0 & 0 \\ 0 & {T}_{b} & 0 & {T}_{g} & 0 & {T}_{d} & 0 & - {T}_{f} \\ 0 & 0 & {T}_{c} & 0 & 0 & 0 & - {T}_{e} & 0 \\ 0 & - {T}_{d} & 0 & {T}_{b} & 0 & {T}_{f} & 0 & - {T}_{g} \\ 0 & 0 & 0 & 0 & {T}_{a} & 0 & 0 & 0 \\ 0 & - {T}_{g} & 0 & - {T}_{f} & 0 & {T}_{b} & 0 & - {T}_{d} \\ 0 & 0 & {T}_{e} & 0 & 0 & 0 & {T}_{c} & 0 \\ 0 & {T}_{f} & 0 & {T}_{d} & 0 & - {T}_{g} & 0 & {T}_{b}\end{matrix} ] . \qquad ( 26 )$$

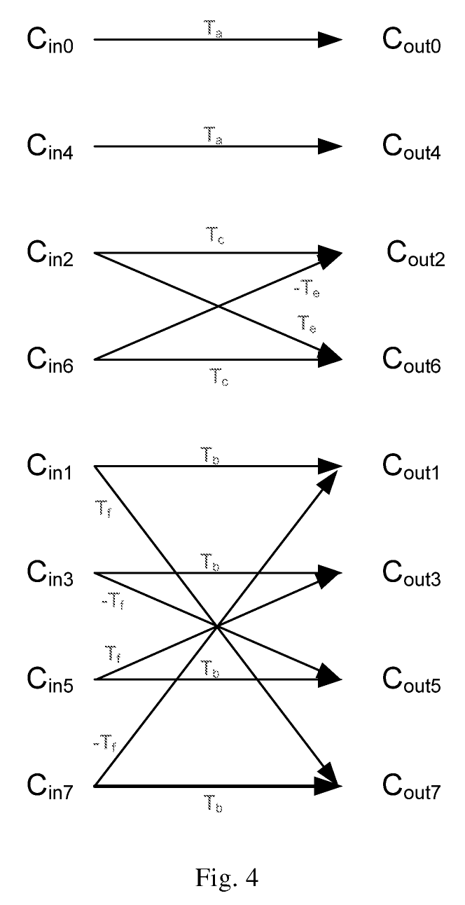

According to the rules, when the coefficients of the input AVS coding matrix are 12-bit or more and the b is 0, the coefficients of the transformed coding matrix C_{wmv} should be represented by 15 bits. According to a preferred embodiment of the present invention, (Tₐ, T_{b}, T_{c}, T_{d}, Tₑ, T_{f}, T_{g})=(768, 714, 736, 0, −16, 34, 0), as shown in FIG. 16. A fast transform method for this transform is shown in FIG. 4.

3. A Transforming from an H.264/AVC Coding Signal into Other Coding Signals.
3.1 A Transform from a H.264/AVC Coding Matrix to a DCT Coding Matrix

A H.264/AVC coding matrix is transformed to a DCT coding matrix via equations (6) and (1), namely:

C_{dct}=T_{dcth264}Cₕ₂₆₄=T_{dct}Eₕ₂₆₄^{t}Kₕ₂₆₄Cₕ₂₆₄ (27)

That is, the transform matrix T_{dcth264} for transforming an H.264/AVC coding matrix into a DCT coding matrix is:

T_{dcth264}=T_{dct}Kₕ₂₆₄Eₕ₂₆₄^{t} (28)

and may be expressed approximately as:

$${T}_{dcth 264} ( \begin{matrix}{T}_{a} , {T}_{b} , {T}_{c} , \\ {T}_{d} , {T}_{e} , {T}_{f} , {T}_{g}\end{matrix} ) \approx {I}_{8} + \frac{1}{{2}^{b}} [ \begin{matrix}{T}_{a} & 0 & 0 & 0 & 0 & 0 & 0 & 0 \\ 0 & {T}_{b} & 0 & {T}_{g} & 0 & {T}_{d} & 0 & - {T}_{f} \\ 0 & 0 & {T}_{c} & 0 & 0 & 0 & - {T}_{e} & 0 \\ 0 & - {T}_{d} & 0 & {T}_{b} & 0 & {T}_{f} & 0 & - {T}_{g} \\ 0 & 0 & 0 & 0 & {T}_{a} & 0 & 0 & 0 \\ 0 & - {T}_{g} & 0 & - {T}_{f} & 0 & {T}_{b} & 0 & - {T}_{d} \\ 0 & 0 & {T}_{e} & 0 & 0 & 0 & {T}_{c} & 0 \\ 0 & {T}_{f} & 0 & {T}_{d} & 0 & - {T}_{g} & 0 & {T}_{b}\end{matrix} ] . \qquad ( 29 )$$

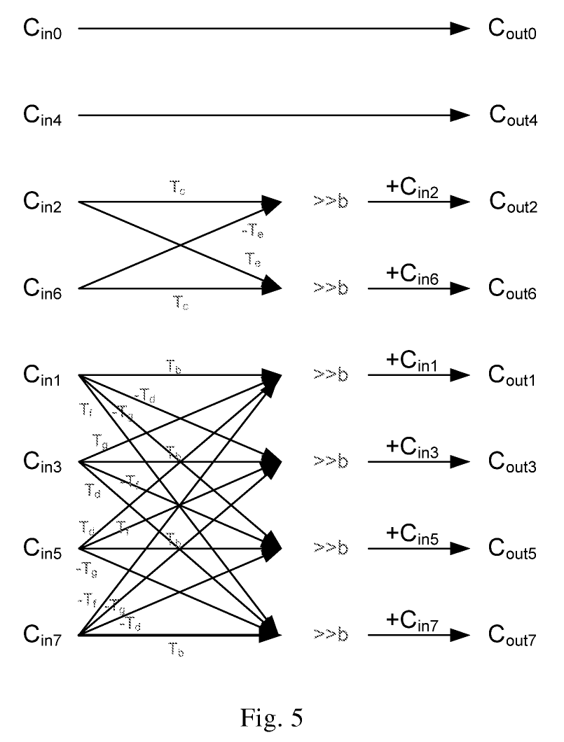

According to the rules, when the coefficients of the input H.264/AVC coding matrix are 12-bit or more and the b is 12, the coefficients of the transformed coding matrix C_{dct} should be represented by 15 bits. According to a preferred embodiment of the present invention, (Tₐ, T_{b}, T_{c}, T_{d}, Tₑ, T_{f}, T_{g})=(0, −7, −10, −81, −290, −199, −89), as shown in FIG. 16. A fast transform method for this transform is shown in FIG. 5.

3.2 A Transform from a H.264/AVC Coding Matrix to an AVS Coding Matrix

A H.264/AVC coding matrix is transformed to an AVS coding matrix via equations (6) and (3), namely:

Cₐᵥₛ=Tₐᵥₛₕ₂₆₄Cₕ₂₆₄=KₐᵥₛKₐᵥₛEₐᵥₛEₕ₂₆₄^{t}Kₕ₂₆₄Cₕ₂₆₄ (30)

That is, the transform matrix Tₐᵥₛₕ₂₆₄ for transforming an H.264/AVC coding matrix into an AVS coding matrix is:

Tₐᵥₛₕ₂₆₄=KₐᵥₛKₐᵥₛEₐᵥₛEₕ₂₆₄^{t}Kₕ₂₆₄ (31)

and may be approximately expressed as:

$${T}_{avsh 264} ( \begin{matrix}{T}_{a} , {T}_{b} , {T}_{c} , \\ {T}_{d} , {T}_{e} , {T}_{f} , {T}_{g}\end{matrix} ) \approx \frac{1}{{2}^{b}} [ \begin{matrix}{T}_{a} & 0 & 0 & 0 & 0 & 0 & 0 & 0 \\ 0 & {T}_{b} & 0 & {T}_{g} & 0 & {T}_{d} & 0 & - {T}_{f} \\ 0 & 0 & {T}_{c} & 0 & 0 & 0 & - {T}_{e} & 0 \\ 0 & - {T}_{d} & 0 & {T}_{b} & 0 & {T}_{f} & 0 & - {T}_{g} \\ 0 & 0 & 0 & 0 & {T}_{a} & 0 & 0 & 0 \\ 0 & - {T}_{g} & 0 & - {T}_{f} & 0 & {T}_{b} & 0 & - {T}_{d} \\ 0 & 0 & {T}_{e} & 0 & 0 & 0 & {T}_{c} & 0 \\ 0 & {T}_{f} & 0 & {T}_{d} & 0 & - {T}_{g} & 0 & {T}_{b}\end{matrix} ] . \qquad ( 32 )$$

According to the rules, when the coefficients of the input H.264/AVC coding matrix are 12-bit or more and the b is 17, the values of Tₐ, T_{b}, T_{c}, T_{d}, Tₑ, T_{f} and T_{g} should be one of the groups shown in the table in FIG. 12, and the coefficients of the transformed coding matrix Cₐᵥₛ should be represented by 15 or more bits, so as to meet the error requirement of the IEEE standard 1180-1990. According to a preferred embodiment of the present invention, (Tₐ, T_{b}, T_{c}, T_{d}, Tₑ, T_{f}, T_{g})=(5793, 6217, 6064, −247, −505, −296, −271), as shown in FIG. 16. A fast transform method for this transform is shown in FIG. 2.

3.3 A Transform from a H.264/AVC Coding Matrix to a WMV9 Coding Matrix

A H.264/AVC coding matrix is transformed to a WMV9 coding matrix via equations (6) and (7), namely:

C_{wmv9}=T_{wmv9h264}Cₕ₂₆₄=E_{wmv9}Eₕ₂₆₄^{t}Kₕ₂₆₄Cₕ₂₆₄ (33)

That is, the transform matrix T_{wmv9h264} for transforming a H.264/AVC coding matrix into a WMV9 coding matrix is:

T_{wmv9h264}=E_{wmv9}Eₕ₂₆₄^{t}Kₕ₂₆₄ (34)

and may be approximately expressed as:

$${T}_{wmv 9 h 264} ( \begin{matrix}{T}_{a} , {T}_{b} , {T}_{c} , \\ {T}_{d} , {T}_{e} , {T}_{f} , {T}_{g}\end{matrix} ) \approx \frac{1}{{2}^{b}} [ \begin{matrix}{T}_{a} & 0 & 0 & 0 & 0 & 0 & 0 & 0 \\ 0 & {T}_{b} & 0 & {T}_{g} & 0 & {T}_{d} & 0 & - {T}_{f} \\ 0 & 0 & {T}_{c} & 0 & 0 & 0 & - {T}_{e} & 0 \\ 0 & - {T}_{d} & 0 & {T}_{b} & 0 & {T}_{f} & 0 & - {T}_{g} \\ 0 & 0 & 0 & 0 & {T}_{a} & 0 & 0 & 0 \\ 0 & - {T}_{g} & 0 & - {T}_{f} & 0 & {T}_{b} & 0 & - {T}_{d} \\ 0 & 0 & {T}_{e} & 0 & 0 & 0 & {T}_{c} & 0 \\ 0 & {T}_{f} & 0 & {T}_{d} & 0 & - {T}_{g} & 0 & {T}_{b}\end{matrix} ] . \qquad ( 35 )$$

According to the rules, when the coefficients of the input H.264/AVC coding matrix are 12-bit or more and the b is 8, the coefficients of the transformed coding matrix C_{wmv} should be represented by 15 bits, so as to meet the error requirement of the IEEE standard 1180-1990. According to a preferred embodiment of the present invention, (Tₐ, T_{b}, T_{c}, T_{d}, Tₑ, T_{f}, T_{g})=(8689, 8689, 8701, −362, −916, 0, −362), as shown in FIG. 16. A fast transform method for this transform is shown in FIG. 2.

4. A Transforming from a WMV9 Coding Signal into Other Coding Signals
4.1 A Transform from a WMV9 Coding Matrix to a DCT Coding Matrix

A WMV9 coding matrix is transformed to a DCT coding matrix via equations (8) and (1), namely:

C_{dct}=T_{dctwmv9}C_{wmv9}=T_{dct}E_{wmv}^{t}K_{wmv}K_{wmv}C_{wmv9} (36)

That is, the transform matrix T_{dctwmv} for transforming a WMV9 coding matrix into a DCT coding matrix is:

T_{dctwmv}=T_{dct}E_{wmv}^{t}K_{wmv}K_{wmv} (37)

and can be approximately expressed as:

$${T}_{dctwmv} ( \begin{matrix}{T}_{a} , {T}_{b} , {T}_{c} , \\ {T}_{d} , {T}_{e} , {T}_{f} , {T}_{g}\end{matrix} ) \approx \frac{1}{{2}^{b}} [ \begin{matrix}{T}_{a} & 0 & 0 & 0 & 0 & 0 & 0 & 0 \\ 0 & {T}_{b} & 0 & {T}_{g} & 0 & {T}_{d} & 0 & - {T}_{f} \\ 0 & 0 & {T}_{c} & 0 & 0 & 0 & - {T}_{e} & 0 \\ 0 & - {T}_{d} & 0 & {T}_{b} & 0 & {T}_{f} & 0 & - {T}_{g} \\ 0 & 0 & 0 & 0 & {T}_{a} & 0 & 0 & 0 \\ 0 & - {T}_{g} & 0 & - {T}_{f} & 0 & {T}_{b} & 0 & - {T}_{d} \\ 0 & 0 & {T}_{e} & 0 & 0 & 0 & {T}_{c} & 0 \\ 0 & {T}_{f} & 0 & {T}_{d} & 0 & - {T}_{g} & 0 & {T}_{b}\end{matrix} ] . \qquad ( 38 )$$

According to the rules, when the coefficients of the input WMV9 coding matrix are 12-bit or more and the b is 17, the values of Tₐ, T_{b}, T_{c}, T_{d}, Tₑ, T_{f} and T_{g} should be one of the groups shown in the table in FIG. 14, and the coefficients of the transformed coding matrix C_{dct} should be represented by 15-bit or more, so as to meet the error requirement of the IEEE standard 1180-1990. Preferably, (Tₐ, T_{b}, T_{c}, T_{d}, Tₑ, T_{f}, T_{g})=(3862, 3849, 3833, 76, 130, −187, 84), as shown in FIG. 16. A fast transform method is shown in FIG. 2.

4.2 A Transform from a WMV9 Coding Matrix to AVS Coding Matrix

A WMV9 coding matrix is transformed to an AVS coding c matrix via equations (8) and (3), namely:

Cₐᵥₛ=T_{avswmv9}C_{wmv9}=KₐᵥₛKₐᵥₛEₐᵥₛE_{wmv}^{t}K_{wmv}K_{wmv}C_{wmv9} (39)

That is, the transform matrix T_{avswmv} for transforming a WMV9 coding matrix into an AVS coding matrix is:

T_{avswmv}=KₐᵥₛKₐᵥₛEₐᵥₛE_{wmv}^{t}K_{wmv}K_{wmv} (40)

and can be approximately expressed as:

$${T}_{avswmv} ( \begin{matrix}{T}_{a} , {T}_{b} , {T}_{c} , \\ {T}_{d} , {T}_{e} , {T}_{f} , {T}_{g}\end{matrix} ) \approx \frac{1}{{2}^{b}} [ \begin{matrix}{T}_{a} & 0 & 0 & 0 & 0 & 0 & 0 & 0 \\ 0 & {T}_{b} & 0 & {T}_{g} & 0 & {T}_{d} & 0 & - {T}_{f} \\ 0 & 0 & {T}_{c} & 0 & 0 & 0 & - {T}_{e} & 0 \\ 0 & - {T}_{d} & 0 & {T}_{b} & 0 & {T}_{f} & 0 & - {T}_{g} \\ 0 & 0 & 0 & 0 & {T}_{a} & 0 & 0 & 0 \\ 0 & - {T}_{g} & 0 & - {T}_{f} & 0 & {T}_{b} & 0 & - {T}_{d} \\ 0 & 0 & {T}_{e} & 0 & 0 & 0 & {T}_{c} & 0 \\ 0 & {T}_{f} & 0 & {T}_{d} & 0 & - {T}_{g} & 0 & {T}_{b}\end{matrix} ] . \qquad ( 41 )$$

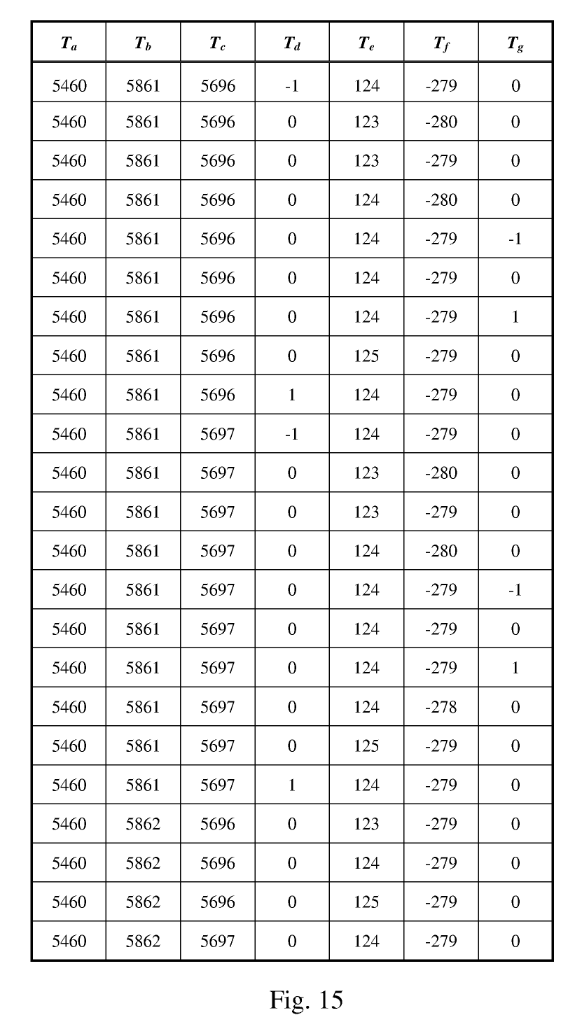

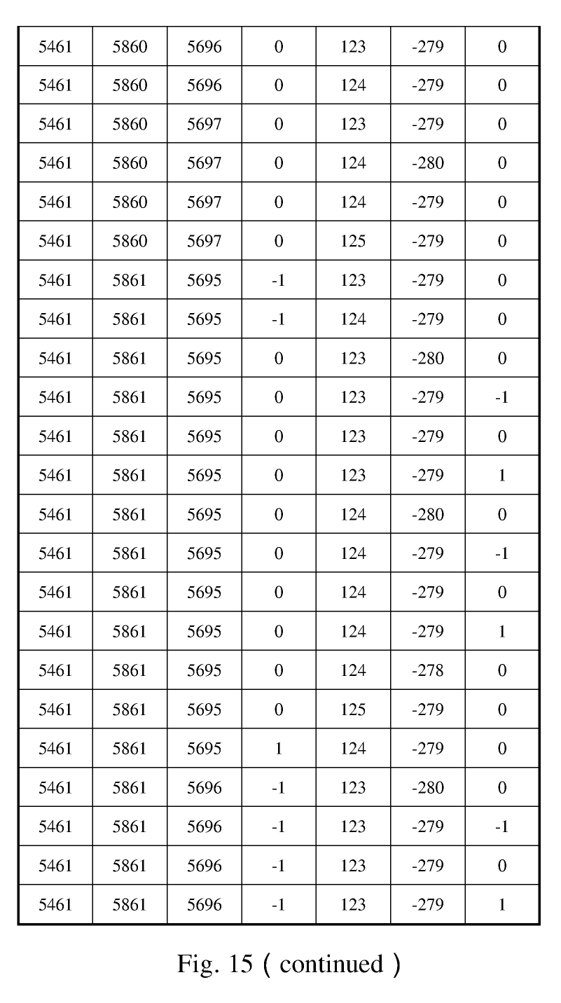

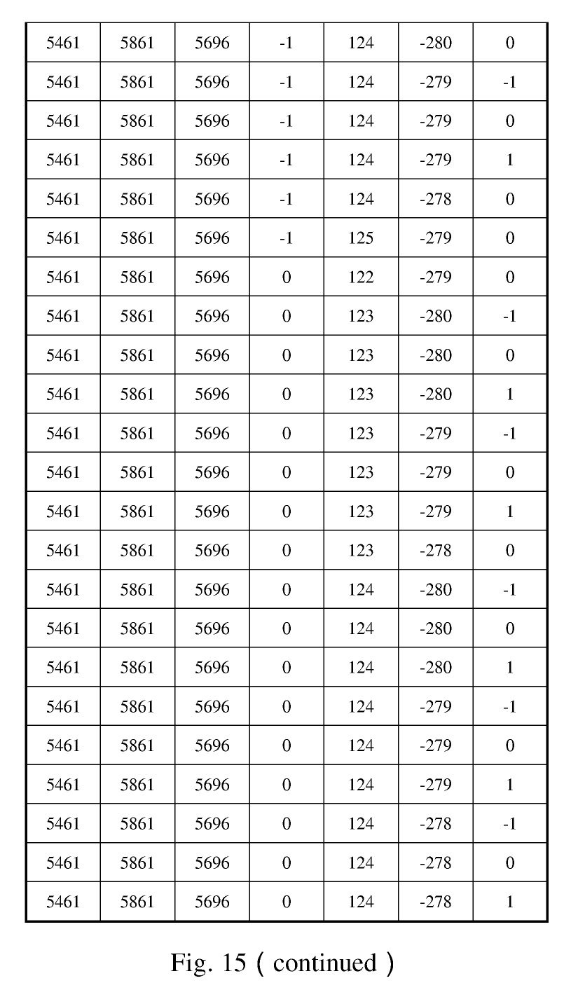

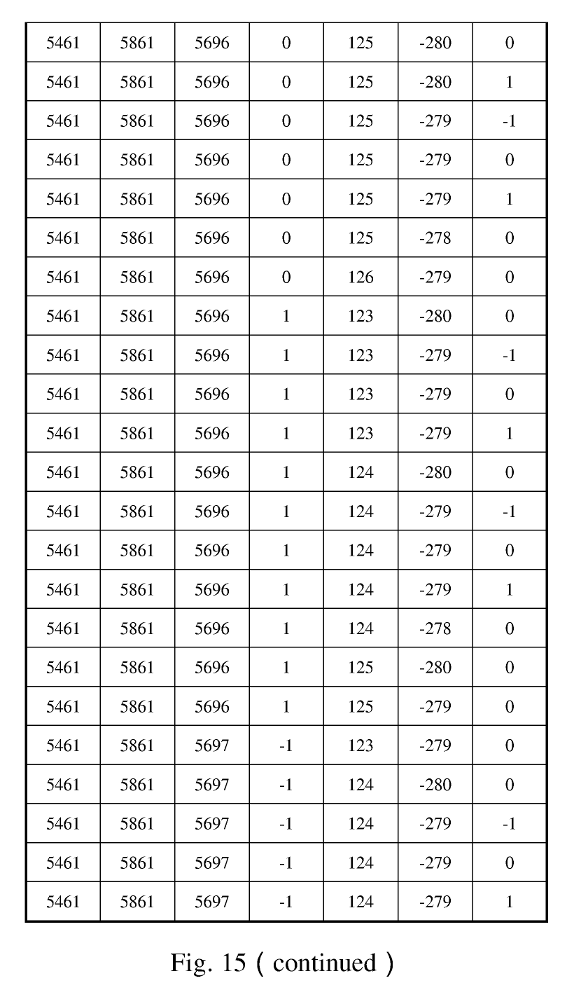

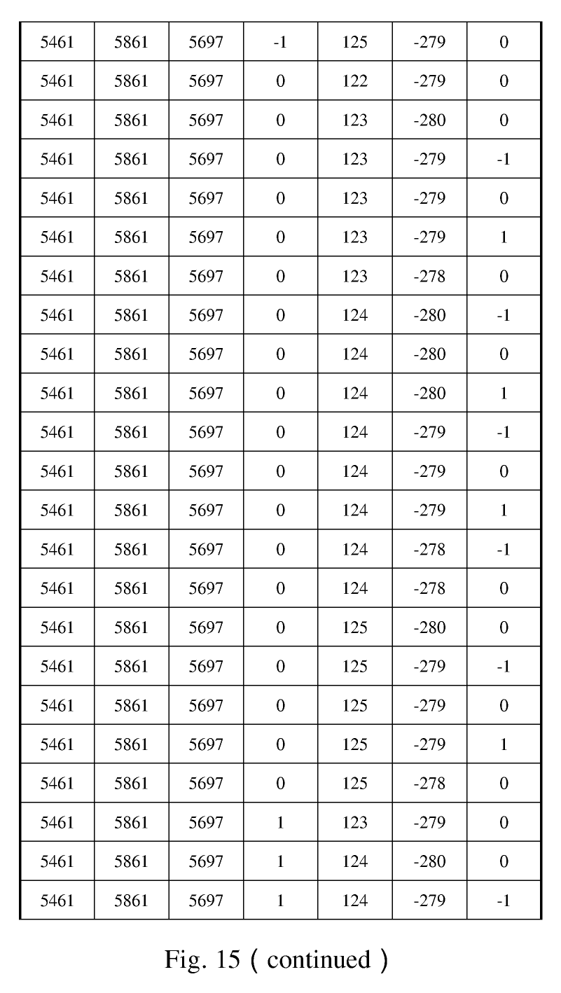

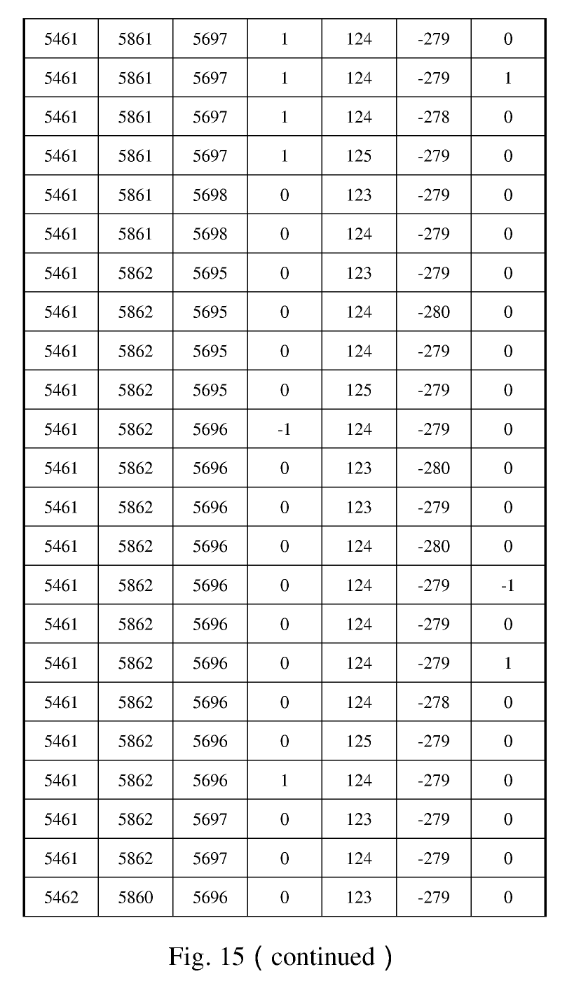

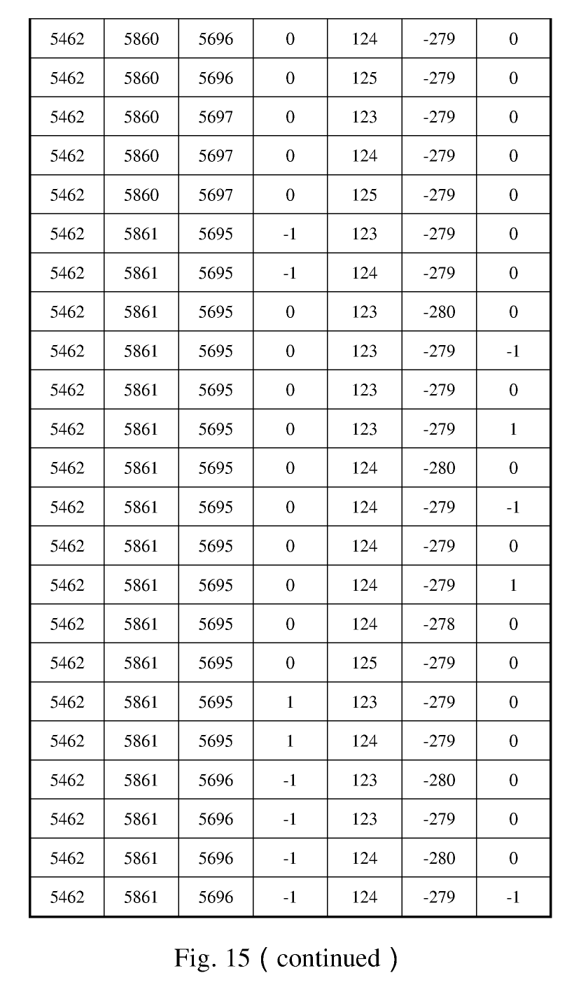

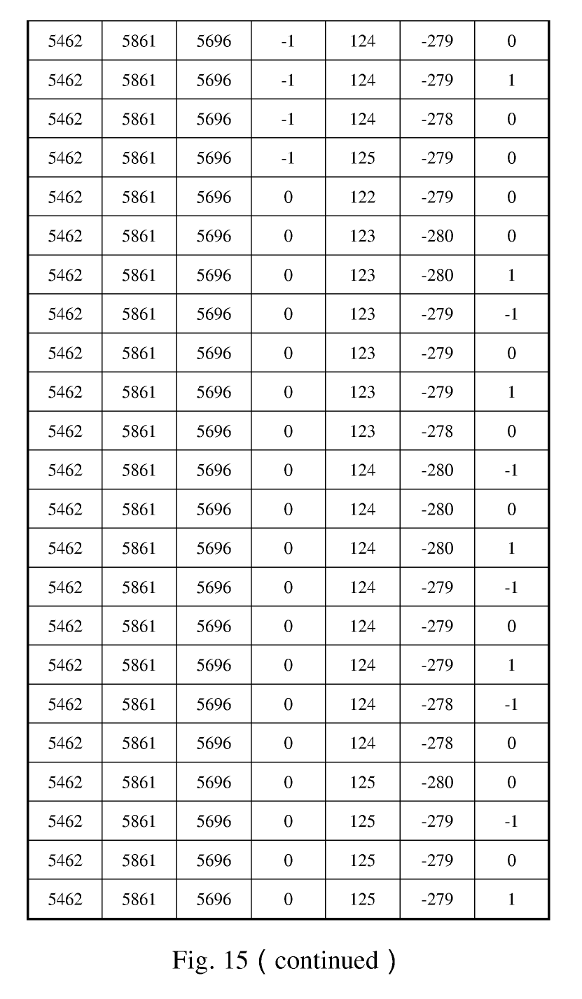

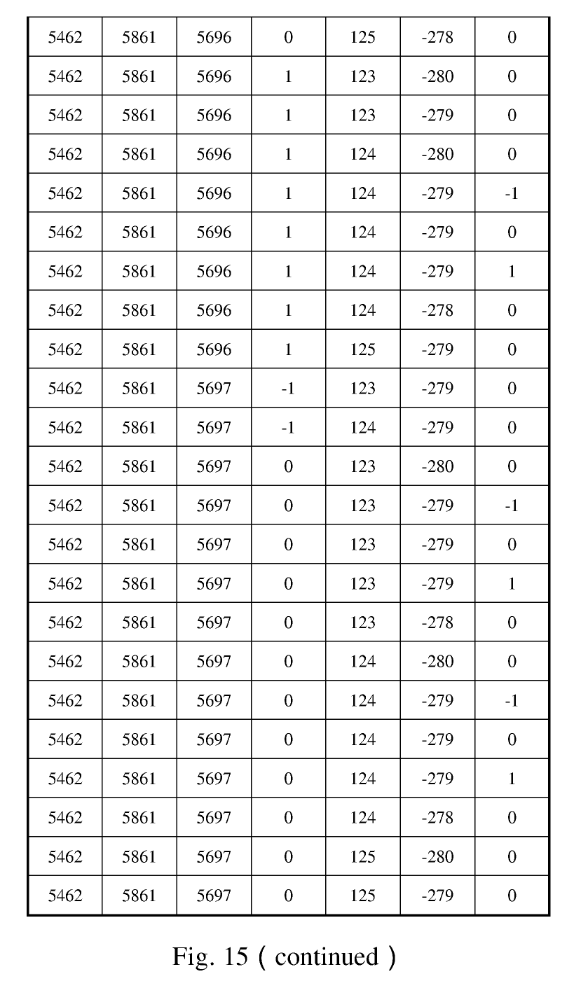

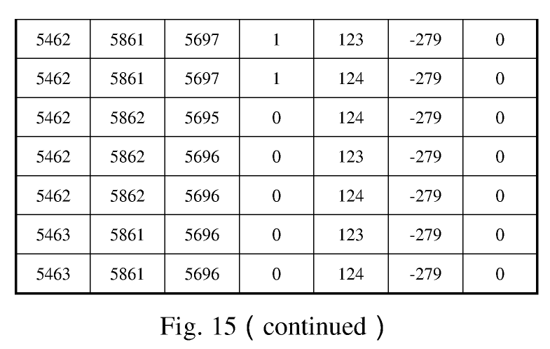

According to the rules, when the coefficients of the input WMV9 coding coefficient are 12-bit or more and the b is 22, the values of Tₐ, T_{b}, T_{c}, T_{d}, Tₑ, T_{f} and T_{g} should be one of the groups shown in the table in FIG. 15, and the coefficients of the transformed matrix Cₐᵥₛ should be represented by 15-bit or more, so as to meet the error requirement of the IEEE standard 1180-1990. Preferably, (Tₐ, T_{b}, T_{c}, T_{d}, Tₑ, T_{f}, T_{g})=(22, 5461, 5861, 0, 124, −279, 0), as shown in FIG. 16. A fast transform method for this transform is shown in FIG. 2.

4.3 A Transform from a WMV9 Coding Matrix to a H.264/AVC Coding Matrix

A WMV9 coding matrix is transformed to a H.264/AVC coding matrix via equations (8) and (5), namely:

Cₕ₂₆₄=T_{h264wmv9}C_{wmv9}=Kₕ₂₆₄Eₕ₂₆₄E_{wmv}^{t}K_{wmv}K_{wmv}C_{wmv9} (42)

That is, the transform matrix T_{h264wmv9} for transforming a WMV9 coding matrix into a H.264/AVC coding matrix is:

T_{h264wmv}=Kₕ₂₆₄Eₕ₂₆₄E_{wmv}^{t}K_{wmv}K_{wmv} (43)

and can be approximately expressed as:

$${T}_{avswmv} ( \begin{matrix}{T}_{a} , {T}_{b} , {T}_{c} , \\ {T}_{d} , {T}_{e} , {T}_{f} , {T}_{g}\end{matrix} ) \approx \frac{1}{{2}^{b}} [ \begin{matrix}{T}_{a} & 0 & 0 & 0 & 0 & 0 & 0 & 0 \\ 0 & {T}_{b} & 0 & {T}_{g} & 0 & {T}_{d} & 0 & - {T}_{f} \\ 0 & 0 & {T}_{c} & 0 & 0 & 0 & - {T}_{e} & 0 \\ 0 & - {T}_{d} & 0 & {T}_{b} & 0 & {T}_{f} & 0 & - {T}_{g} \\ 0 & 0 & 0 & 0 & {T}_{a} & 0 & 0 & 0 \\ 0 & - {T}_{g} & 0 & - {T}_{f} & 0 & {T}_{b} & 0 & - {T}_{d} \\ 0 & 0 & {T}_{e} & 0 & 0 & 0 & {T}_{c} & 0 \\ 0 & {T}_{f} & 0 & {T}_{d} & 0 & - {T}_{g} & 0 & {T}_{b}\end{matrix} ] . \qquad ( 44 )$$

According to the rules, when the coefficients of the input WMV9 coding matrix are 12-bit or more and the b is 16, the coefficients of the transformed coding matrix C_{wmv} should be represented by 15 bits. Preferably, (Tₐ, T_{b}, T_{c}, T_{d}, Tₑ, T_{f}, T_{g})=(1931, 1924, 1907, 80, 201, 0, 80). A fast transform method for this transform is shown in FIG. 2.

The transform between DCT coding coefficients and ICT coding coefficients as well as the transforms among three different ICT coding coefficients are given from the point of view of mathematics. Accordingly, a device for transform of coding coefficients of video signals is illustrated according to the invention with reference to drawings.

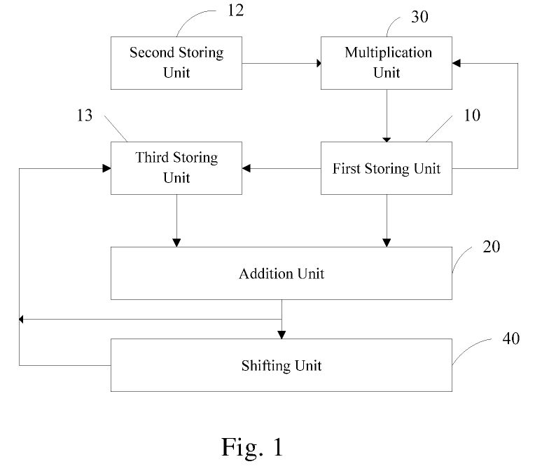

FIG. 1 is a block diagram for showing a device 100 for transform of coding coefficients according to one preferable embodiment of the present invention, comprising a first storage unit 10, a second storage unit 12, a third storage unit 13, a multiplication unit 30, an addition unit 20 and a shifting unit 40.

The device 100 will be described by taking the transform from DCT coding coefficients to AVS coding coefficients as an example.

The first storage unit 10 stores coding coefficients to be transformed, i.e., coding coefficients of input signals, which are extracted from input video. In the embodiment, the stored coding coefficients are represented as a coding matrix C_{dct}.

The second storage unit 12 stores the transform matrix, i.e., the transform matrix T_{avsdct} for the transform from DCT coding coefficients to AVS coding coefficients in this embodiment. In this embodiment, T_{avsdct} is set as (Tₐ, T_{b}, T_{c}, T_{d}, Tₑ, T_{f}, T_{g})=(5793, 6232, 6048, −130, −74, 7, −130). Values in the matrix are variable according to different transform methods and accuracies. For example, the matrix for the transform from AVS coding coefficients to DCT coding coefficients may take values of Tₐ, T_{b}, T_{c}, T_{d}, Tₑ, T_{f} and T_{g} from one of the groups in FIG. 10.

In one embodiment of the present invention, said transform matrix stored in the second storage unit and the coding coefficients stored in the first storage unit are loaded manually. That is, coding modes for input signals and output signals are designated prior to the transform. Then, coding coefficients and transform matrixes are loaded based on the designated coding modes. It will be appreciated for those skilled in the art that various manners may be used to store and read coding coefficients and the transform matrixes, for example, stored in a known storage device and read out via a preset program. Optionally, all values of the coding coefficients and the transform matrixes may be programmed into program codes and used by presetting in the program codes.

The multiplication unit 30 multiplies the coding coefficients stored in the first storing unit 10 by the transform matrix stored in the second storing unit 12 and outputs the multiplication result into the first storing unit 10 for storage. Alternatively, the multiplication result may be stored in other storing units.

The third storage unit 13 stores intermediate results rendered by operations of the addition unit 20 and the shifting unit 40 as well as the final result of the transform. Specifically, the third storage unit 13 is reset before the transform. The addition unit 20 adds up the results stored in the first and the third storage units, and outputs of the addition unit 20 temperately stores in the third storage unit 13.

The shifting unit 40 performs a shifting operation on values stored in the third storage unit 13. In this embodiment, the shifting unit 40 shifts the result stored in the third storage unit 13 right by predetermined bits. The shifting results are also stored in the third storage unit 13. As a result, what finally stores in the third storage unit 13 are just the transformed coefficients, i.e., the AVS coding matrix Cₐᵥₛ.

Although the device 100 is described with reference to the transform from DCT coding coefficients to AVS coding coefficients, it will be understandable for those skilled in the art that, with respect to various transforms between coding coefficients of different coding modes, the order of operations of units in the device 100 may different. For example, when performing a transform from DCT coding coefficients to H.264/AVC coding coefficients, the addition unit 20 performs one more addition operation after shifting operation performed by shifting unit 40. Another example is, when coding matrix Cₕ₂₆₄₂ for H.264/AVC are calculated, the multiplication unit 30 multiplies coding matrix T_{c} by C_{dct2} and multiplies Tₑ by C_{dct6} firstly. The addition unit 20 adds up the results of two multiplying operations. Then, the shifting unit 40 performs shifting operation on the addition result of the addition device 20. Finally, the addition unit 20 adds up the shifting result of the shifting means 40 and coding matrix C_{dct2} so as to obtain coding matrix Cₕ₂₆₄₂. This procedure may be represented by an equation of signal flow:

Cₕ₂₆₄₂=(T_{c}*C_{dct2}−Tₑ*C_{dct6})>>b+C_{dct2}.

Hereinafter, steps for transform among coefficients of various coding modes performed by the device 100 will be described in detail.

Signal flow graphs of various coding coefficient transform methods will be described below by illustration, so as to clearly show how the transforms among coefficients of various coding modes are achieved in the preferable embodiment of the present invention.

FIG. 2 is a signal flow graph for showing a method for a fast transform of coding coefficients according to one embodiment of the present invention. FIG. 3 is a signal flow graph for showing a method for a fast transform from DCT coding coefficients to H.264/AVC coding coefficients according to another embodiment of the present invention. The fast transform may be simplified if a portion of the coefficients is zero, which may be shown in the transform from AVS to WMV9 in FIG. 4 and the transform from H.264/AVC to DCT in FIG. 5.

Referring to FIG. 2, the transform from DCT coding coefficients to AVS coding coefficients may be described as follows:

Cₐᵥₛ₀=C_{dct0}*Tₐ>>b

Cₐᵥₛ₄=C_{dct4}*Tₐ>>b

Cₐᵥₛ₂=(T_{c}*C_{dct2}−Tₑ*C_{dct6})>>b

Cₐᵥₛ₆=(T_{c}*C_{dct6}+Tₑ*C_{dct2})>>b

Cₐᵥₛ₁=(T_{b}*C_{dct1}+T_{g}*C_{dct3}+T_{d}*C_{dct5}−T_{f}*C_{dct7})>>b

Cₐᵥₛ₃=(−T_{d}*C_{dct1}+T_{b}*C_{dct3}+T_{f}*C_{dct5}−T_{g}*C_{dct7})>>b

Cₐᵥₛ₅=(−T_{g}*C_{dct1}−T_{f}*C_{dct3}+T_{b}*C_{dct5}+T_{d}*C_{dct7})>>b

Cₐᵥₛ₇=(T_{f}*C_{dct1}+T_{d}*C_{dct3}−T_{g}*C_{dct5}+T_{b}*C_{dct7})>>b.

Referring to FIG. 3, the transform from DCT coding coefficients to H.264/AVC coding coefficients may be described as follows:

Cₕ₂₆₄₀=C_{dct0}*Tₐ>>b+C_{dct0}

Cₕ₂₆₄₄=C_{dct4}*Tₐ>>b+C_{dct4}

Cₕ₂₆₄₂=(T_{c}*C_{dct2}−Tₑ*C_{dct6})>>b+C_{dct2}

Cₕ₂₆₄₆=(T_{c}*C_{dct6}+Tₑ*C_{dct2})>>b+C_{dct6}

Cₕ₂₆₄₁=(T_{b}*C_{dct1}+T_{g}*C_{dct3}+T_{d}*C_{dct5}−T_{f}*C_{dct7})>>b+C_{dct1}

Cₕ₂₆₄₃=(−T_{d}*C_{dct1}+T_{b}*C_{dct3}+T_{f}*C_{dct5}−T_{g}*C_{dct7})>>b+C_{dct3}

Cₕ₂₆₄₅=(−T_{g}*C_{dct1}−T_{f}*C_{dct3}+T_{b}*C_{dct5}+T_{d}*C_{dct7})>>b+C_{dct5}

Cₕ₂₆₄₇=(T_{f}*C_{dct1}+T_{d}*C_{dct3}−T_{g}*C_{dct5}+T_{b}*C_{dct7})>>b+C_{dct7}

wherein the symbol “>>b” represents shifting right by b bits.

Hereinafter, a transform from DCT coding coefficients to AVS coding coefficients (referred to as “forward transform”) is described with reference to FIGS. 1 and 2, respectively, wherein calculating Cₐᵥₛ₇ is exemplified, comprising steps of
1) resetting the third storage unit;
2) loading DCT coding matrix C_{dct} of signals compressed by DCT into the first storage unit 10;
3) loading a transform matrix T_{avsdc} into the second storage unit 12;
4) multiplying the DCT coding matrix C_{dct} in the first storage unit 10 by the transform matrix T_{avsdc} in the second storage unit, namely, the multiplication unit 30 performs T_{f}*C_{dct1}, and storing the multiplication result in the first storage unit 10;
5) adding up the values stored in the first and third storage units, namely, the addition unit 20 adds T_{d}*C_{dct3}, −T_{g}*C_{dct5} and T_{b}*C_{dct7}, and storing the result of addition in the third storage unit 13; and
6) shifting the result of step 5) right by predetermined bits (i.e., b bits) and storing the shifted result Cₐᵥₛ₇ in the third storage unit 13.

In steps 2) and 3), the loading may be performed one parameter by one parameter in C_{dct} and T_{avsdct}. Alternatively, all parameters in C_{dct} and T_{avsdct} may be loaded at one time. It will be appreciated that, when the loading is done one by one, steps 2) to 5) should be repeated. For example, T_{f} and C_{dct1} are loaded firstly and multiplied in step 4). The multiplication result is then stored in the first storage unit 10. In step 5), this multiplication result is added to the value stored in the third storage unit 13 and the procedure then returns to step 2) to perform operations on the rest parameters.

A transform from the AVS coding coefficients to the DCT coding coefficients (referred to “reverse transform”) is similar to the above-mentioned forward transform. In view of the foregoing description and FIG. 3, the reverse transform is apparent for those skilled in the art.

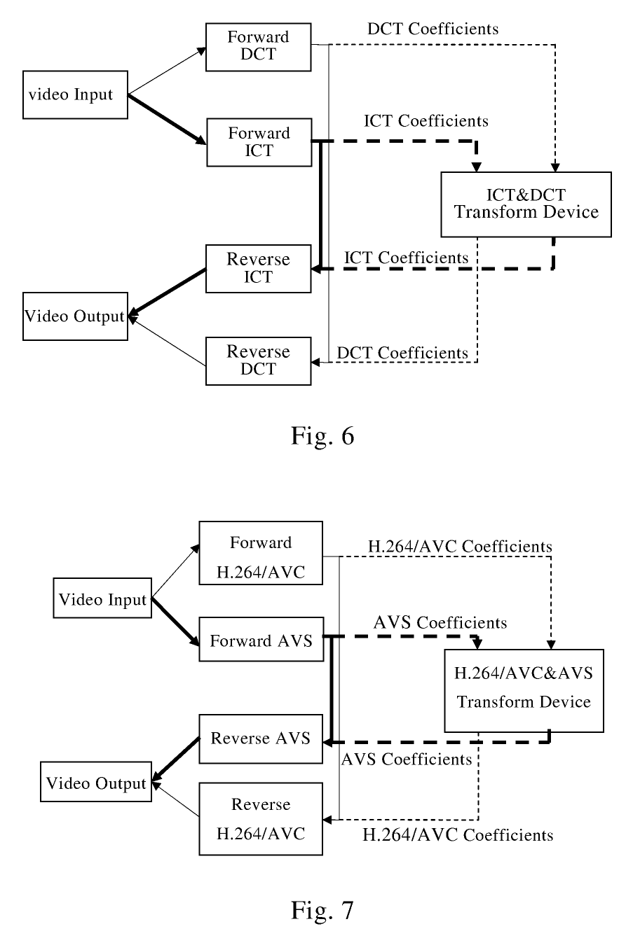

FIG. 6 schematically shows a fast transform between DCT coding coefficients and ICT coding coefficients, wherein thick solid lines and thin solid lines show a conventional ICT process and a DCT process, respectively. Conventionally, the coding coefficients for the two processes are not exchangeable. However, the present invention can realize the exchange of coding coefficients of two processes. Specifically, when input video signals are compressed into digital video data by DCT (forward DCT transform), DCT coding coefficients are extracted from the video data (as shown by the thin dashed line) and transformed to ICT coding coefficients (as shown by the thick dashed line). The video signals with ICT coding coefficients are decoded (inverse ICT transform) and then output. Extracting DCT coding coefficients from video data is known to the art and thus is not described in detail.

FIG. 7 schematically shows a fast transform between a H.264/AVC coding coefficient and an AVS coding coefficient according to the present invention, wherein thick solid line and thin solid line show a conventional H.264/AVC process and an AVS process, respectively. Conventionally, the coding coefficients for the two processes are not exchangeable. However, the present invention can realize the exchange of coding coefficients of two processes. Specifically, when input video signals are compressed into digital video data by H.264/AVC (forward H.264/AVC transform), H.264/AVC coding coefficients are extracted from the video data (as shown by the thick dashed line) and transformed to AVS coding coefficients (as shown by the thin dashed line). The AVS coding coefficients are decoded (inverse AVS transform) and then output. Similarly, when the input video signals are compressed into digital video data by AVS (forward AVS transform), the AVS coding coefficients are extracted from the video data (as shown by the thick dashed line) and transformed to H.264/AVC coding coefficients (as shown by the thin dashed line). The H.264/AVC coding coefficients are decoded (inverse H.264/AVC transform) and then output. Other transforms, such as that between H.264 and MSWM9 as well as that between AVS and MSWM9, may be performed by similar methods, and are thus not described in detail.

Though embodiments and implementations of the invention have been shown and described, it should be apparent that many more embodiments and implementations are within the scope of the invention. Accordingly, the invention is not to be restricted, except in light of the claims and their equivalents.

1. A device for transforming video signals with first coding coefficients of into video signals with second coding coefficients, comprising:
a first storage unit configured to store the first coding coefficients;
a second storage unit configured to store a transform matrix;
a multiplication unit configured to perform a multiplication operation for the first coding coefficients and the transform matrix;
an addition unit configured to add values resulted from the multiplication operation; and
a shifting unit configured to shift values resulted from the addition unit to obtain the second coding coefficients.

2. The device according to claim 1, wherein the first coding coefficients are DCT video coding coefficients and the second coding coefficients are ICT video coding coefficients.

3. The device according to claim 1, wherein the first coding coefficients are ICT video coding coefficients and the second coding coefficients are ICT video coding coefficients different from the first coding coefficients.

4. The device according to claim 1, wherein the first coding coefficients are ICT video coding coefficients and the second coding coefficients are DCT video coding coefficients.

5. The device according to claim 2, wherein the ICT video coding coefficients comply with one of International Standards of WMV9, AVS and H.264/AVC.

6. The device according to claim 5, wherein the transform matrix is set up such that an error between a first signal vector and a second signal vector meet the error-requirement of the IEEE standard 1180-1990, wherein the first signal vector is transformed from the first coding coefficients by using a reverse coding in accordance with the error-requirement provided in IEEE standard 1180-1990, and the second signal vector is transformed from the second coding coefficients by using a reverse coding in accordance with the error-requirement provided in IEEE standard 1180-1990.

7. The device according to claim 6, wherein the ICT video coding coefficients make up of an eight-order ICT coding matrix.

8. The device according to claim 7, further comprising:
a third storage unit configured to store outputs from the addition unit and from the shifting unit.

9. The device according to claim 8, wherein the shifting unit shifts the values resulted from the addition unit right by 17, 13, 15, 8, 0, 12, 22 or 16 bits.

10. The device according to claim 9, wherein the second coding coefficients are 15-bit.

11. A method for transforming video signals with first coding coefficients into video signals with second coding coefficients, comprising:
loading the first coding coefficients and a transform matrix;
multiplying the first coding coefficients by the transform matrix;
adding values resulted from the multiplication operation; and
shifting values resulted from the adding operation to obtain the second coding coefficients.

12. The method according to claim 11, wherein the first coding coefficients are DCT video coding coefficients and the second coding coefficients are ICT video coding coefficients.

13. The method according to claim 11, wherein the first coding coefficients are ICT video coding coefficients and the second coding coefficients are ICT video coding coefficients different from the first coding coefficients.

14. The method according to claim 11, wherein the first coding coefficients are ICT video coding coefficients and the second coding coefficients are DCT video coding coefficients.

15. The method according to claim 12, wherein the ICT video coding coefficients comply with one of International Standards of WMV9, AVS and H.264/AVC.

16. The method according to claim 15, wherein the transform matrix is set up such that an error between a first signal vector and a second signal vector meet the error-requirement of the IEEE standard 1180-1990, wherein the first signal vector is transformed from the first of coding coefficients by using a reverse coding in accordance with the error-requirement provided in IEEE standard 1180-1990, and the second signal vector is transformed from the second coding coefficients by using a reverse coding in accordance with the error-requirement provided in IEEE standard 1180-1990.

17. The method according to claim 16, wherein the ICT video coding coefficients make up of an eight-order ICT coding matrix.

18. The method according to claim 17, wherein the shifting further comprises:
shifting values resulted from the adding operation right by 17, 13, 15, 8, 0, 12, 22 or 16 bits to obtain the second coding coefficients.

19. The method according to claim 18, wherein the second coding coefficients are 15-bit.

20. The method according to claim 11, further comprising:
storing the first coding coefficients, the transform matrix, and each of values resulted from the multiplying, adding and shifting.

21. The device according to claim 3, wherein the ICT video coding coefficients comply with one of International Standards of WMV9, AVS and H.264/AVC.

22. The device according to claim 21, wherein the transform matrix is set up such that an error between a first signal vector and a second signal vector meet the error-requirement of the IEEE standard 1180-1990, wherein the first signal vector is transformed from the first coding coefficients by using a reverse coding in accordance with the error-requirement provided in IEEE standard 1180-1990, and the second signal vector is transformed from the second coding coefficients by using a reverse coding in accordance with the error-requirement provided in IEEE standard 1180-1990.

23. The device according to claim 22, wherein the ICT video coding coefficients make up of an eight-order ICT coding matrix.

24. The device according to claim 23, further comprising:
a third storage unit configured to store outputs from the addition unit and from the shifting unit.

25. The device according to claim 24, wherein the shifting unit shifts the values resulted from the addition unit right by 17, 13, 15, 8, 0, 12, 22 or 16 bits.

26. The device according to claim 25, wherein the second coding coefficients are 15-bit.

27. The device according to claim 4, wherein the ICT video coding coefficients comply with one of International Standards of WMV9, AVS and H.264/AVC.

28. The device according to claim 27, wherein the transform matrix is set up such that an error between a first signal vector and a second signal vector meet the error-requirement of the IEEE standard 1180-1990, wherein the first signal vector is transformed from the first coding coefficients by using a reverse coding in accordance with the error-requirement provided in IEEE standard 1180-1990, and the second signal vector is transformed from the second coding coefficients by using a reverse coding in accordance with the error-requirement provided in IEEE standard 1180-1990.

29. The device according to claim 28, wherein the ICT video coding coefficients make up of an eight-order ICT coding matrix.

30. The device according to claim 29, further comprising:
a third storage unit configured to store outputs from the addition unit and from the shifting unit.

31. The device according to claim 30, wherein the shifting unit shifts the values resulted from the addition unit right by 17, 13, 15, 8, 0, 12, 22 or 16 bits.

32. The device according to claim 31, wherein the second coding coefficients are 15-bit.

33. The method according to claim 13, wherein the ICT video coding coefficients comply with one of International Standards of WMV9, AVS and H.264/AVC.

34. The method according to claim 33, wherein the transform matrix is set up such that an error between a first signal vector and a second signal vector meet the error-requirement of the IEEE standard 1180-1990, wherein the first signal vector is transformed from the first of coding coefficients by using a reverse coding in accordance with the error-requirement provided in IEEE standard 1180-1990, and the second signal vector is transformed from the second of coding coefficients by using a reverse coding in accordance with the error-requirement provided in IEEE standard 1180-1990.

35. The method according to claim 34, wherein the ICT video coding coefficients make up of an eight-order ICT coding matrix.

36. The method according to claim 35, wherein, in the shifting further comprises:
shifting values resulted from the adding operation right by 17, 13, 15, 8, 0, 12, 22 or 16 bits to obtain the second coding coefficients.

37. The method according to claim 36, wherein the second coding coefficients are 15-bit.

38. The method according to claim 14, wherein the ICT video coding coefficients comply with one of International Standards of WMV9, AVS and H.264/AVC.

39. The method according to claim 38, wherein the transform matrix is set up such that an error between a first signal vector and a second signal vector meet the error-requirement of the IEEE standard 1180-1990, wherein the first signal vector is transformed from the first of coding coefficients by using a reverse coding in accordance with the error-requirement provided in IEEE standard 1180-1990, and the second signal vector is transformed from the second coding coefficients by using a reverse coding in accordance with the error-requirement provided in IEEE standard 1180-1990.

40. The method according to claim 39, wherein the ICT video coding coefficients make up of an eight-order ICT coding matrix.

41. The method according to claim 40, wherein the shifting further comprises:
shifting values resulted from the adding operation right by 17, 13, 15, 8, 0, 12, 22 or 16 bits to obtain the second coding coefficients.

42. The method according to claim 41, wherein the second coding coefficients are 15-bit.
